(19) United States
(12) Patent Application Publication
(10) Pub. No.: US 2025/0349901 A1
(43) Pub. Date: Nov. 13, 2025

(54) NON-AQUEOUS ELECTROLYTE FOR LITHIUM SECONDARY BATTERY

(71) Applicant: LG Energy Solution, Ltd., Seoul (KR)

(72) Inventors: Sung Guk Park, Daejeon (KR); Chul Haeng Lee, Daejeon (KR); Jung Min Lee, Daejeon (KR)

(21) Appl. No.: 19/200,575

(22) Filed: May 6, 2025

(30) Foreign Application Priority Data
May 7, 2024 (KR) 10-2024-0060184
Mar. 21, 2025 (KR) 10-2025-0036780

(51) Int. Cl. H01M 10/0569; H01M 10/0525

(52) U.S. Cl. CPC H01M 10/0569; H01M 10/0525; H01M 2300/0034; H01M 2300/004

(57) ABSTRACT

Disclosed is a non-aqueous electrolyte including a lithium salt and an organic solvent. The organic solvent includes a cyclic carbonate and a compound represented by Chemical Formula 1:

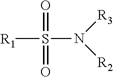

R1 is a fluorine atom, an alkyl group having 1 to 10 carbon atoms substituted with one or more fluorines, or an alkoxy group having 1 to 10 carbon atoms substituted with one or more fluorines; and R2 and R3 are independently hydrogen, alkyl groups with 1 to 10 carbon atoms, or aryl groups with 6 to 20 carbon atoms.

### CROSS-REFERENCE TO RELATED APPLICATIONS

This application claims the benefit of priority based on Korean Patent Application No. 10-2024-0060184, filed on May 7, 2024, and all contents disclosed in the documents of the said Korean patent application are included as part of this specification. Further, PCT Application No. PCT/KR2025/003679, filed on Mar. 21, 2025, is incorporated herein in its entirely by reference.

### BACKGROUND

The application of lithium secondary batteries spans from power supply for electronic devices such as electricity, electronics, communication, and computers to power storage supply for large-area devices such as automobiles and power storage devices, increasing the demand for secondary batteries with high capacity, high output, and high stability.

The lithium secondary battery is mainly composed of a cathode made of transition metal oxide containing lithium, an anode capable of storing lithium, an electrolyte that serves as a medium for transferring lithium ions, and a separator. Among these, the electrolyte is known to significantly affect the stability and safety of the battery, leading to extensive research on this component.

In this regard, the electrolyte of lithium secondary batteries generally uses a non-aqueous electrolyte containing lithium salts and organic solvents, with carbonate-based organic solvents being commonly used. For example, LiPF6 can be used as the lithium salt. However, the PF6-anion is vulnerable to heat, and when the battery is exposed to high temperatures, thermal decomposition of the lithium salt generates Lewis acids such as HF and PF5. These Lewis acids cause the decomposition of the organic solvent itself and destroy the solid electrolyte interface (SEI) layer formed on the surface of the anode active material, leading to the generation of gases such as CO2 and CH4, which in turn causes an increase in resistance, a decrease in lifespan, and storage performance issues in the lithium secondary battery.

### SUMMARY

One aspect of the present disclosure provides a non-aqueous electrolyte, which comprises a lithium salt; and an organic solvent comprising a cyclic carbonate compound; and a compound represented by Chemical Formula 1-1:

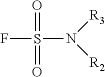

wherein R2 and R3 each are hydrogen, an alkyl group having 1 to 10 carbon atoms, or an aryl group having 6 to 20 carbon atoms. The organic solvent may comprise the compound represented by Chemical Formula 1-1 in an amount from about 10 vol % to about 30 wt %.

In the foregoing non-aqueous electrolyte provided herein, at least one of R2 and R3 may be methyl. In any of the foregoing non-aqueous electrolytes provided herein, the compound represented by Chemical Formula 1-1 may be represented by Chemical Formula 1-A:

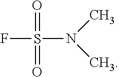

In any of the foregoing non-aqueous electrolytes provided herein, the non-aqueous electrolyte may comprise the compound in an amount of about 20 vol %.

In any of the foregoing non-aqueous electrolytes provided herein, the cyclic carbonate may comprise at least one selected from the group consisting of ethylene carbonate, propylene carbonate (PC), vinylene carbonate (VC), methyl ethylene carbonate (MEC), 1,2-butylene carbonate, 2,3-butylene carbonate, 1,2-pentylene carbonate, 2,3-pentylene carbonate, or methyl vinylene carbonate, ethyl vinylene carbonate, 1,2-dimethyl vinylene carbonate, 1,2-diethyl vinylene carbonate, 1-ethyl-2-vinylethylene carbonate, 1-n-propyl-2-vinylethylene carbonate, 1-methyl-2-vinyl ethylene carbonate, 1,1-divinyl ethylene carbonate, 1,2-divinyl ethylene carbonate, 1,1-dimethyl-2-ethylene carbonate, 1,1-diethyl-2-methylene-ethylene carbonate, fluoroethylene carbonate, 1,2-difluoroethylene carbonate, 1,1-difluoroethylene carbonate, 1,1,2-trifluoroethylene carbonate, tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, and trifluoromethylethylene, fluoro vinylene carbonate, and trifluoromethyl carbonate. In any of the foregoing non-aqueous electrolytes provided herein, the cyclic carbonate comprises ethylene carbonate.

In any of the foregoing non-aqueous electrolytes provided herein, the organic solvent may further comprise at least one linear carbonate compounds selected from the group consisting of dimethyl carbonate (DMC), diethyl carbonate (DEC), dipropyl carbonate (DPC), ethyl methyl carbonate (EMC), methylpropyl carbonate (MPC), and ethyl propyl carbonate (EPC).

Any of the foregoing non-aqueous electrolytes provided herein may further comprise an additional compound selected from the group consisting of a linear ester-based organic compound, a cyclic ester-based organic compound, an ether-based organic compound, a glyme-based compound, and a nitrile-based organic compound, and mixtures thereof.

Any of the foregoing non-aqueous electrolytes provided herein may further comprise an additive selected from the group consisting of lithium difluorophosphate (LiDFP), vinylene carbonate, vinylethylene carbonate, fluoroethylene carbonate, Propane sultone, Propene Sultone, Succino Nitrile (succinonitrile), Adiponitrile, Ethylene sulfate, LiBOB (Lithium bis-(oxalato)borate), LiBF4 (Lithium tetrafluoroborate), LiDFOB (Lithium difluoro (oxalato)borate), LiDFOP (Lithium difluoro bis(oxalato), 3-trimethoxysilanyl-propyl-N-aniline (TMSPa), Tris(trimethylsilyl) Phosphite (TMSPi), a compound represented by Chemical Formula 2, and mixtures thereof.

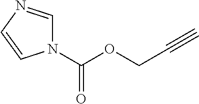

In any of the foregoing non-aqueous electrolytes provided herein, the lithium salt comprising Li+ and an anion selected from the group consisting of F−, Cl−, Br−, I−, NO3−, N(CN)2−, BF4−, ClO4−, AlO4−, AlCl4−, PF6−, SbF6−, AsF6−, B10Cl10−, BF2C2O4−, BC4O8−, PF4C2O4−, PF2C4O8−, (CF3)2PF4−, (CF3)3PF3−, (CF3)4PF2−, (CF3)5PF−, (CF3)6P−, CF3SO3−, C4F9SO3−, CF3CF2SO3−, (FSO2)2N−, CF3CF2(CF3)2CO−, (CF3SO2)2CH−, CH3SO3−, CF3(CF2)7SO3−, CF3CO2−, CH3CO2−, SCN− and (CF3CF2SO2)2N−, and mixtures of.

n any of the foregoing non-aqueous electrolytes provided herein, the non-aqueous electrolyte may comprise the lithium salt at a molar concentration of 0.5 M to 5.0 M.

One aspect of the present disclosure provides a lithium secondary battery comprising: an anode; a cathode facing the anode; a separator interposed between the anode and the cathode; and any of the foregoing non-aqueous electrolytes provided herein.

In the foregoing lithium secondary battery provided herein, the anode includes an anode active material, and the anode active material may include at least one selected from carbon-based active materials and silicon-based active materials.

### EXAMPLE EMBODIMENTS

These and other features of the present disclosure may be understood from the following detailed description and will become more fully apparent from the example embodiments of the present disclosure. Also, it will be easily understood that the objects and advantages of the present disclosure may be realized by the means shown in the appended claims and combinations thereof.

### SUMMARY NOT LIMITING

It is understood that this disclosure is not limited to the examples summarized in this Summary. Various other aspects are described and exemplified herein.

### DETAILED DESCRIPTION

### Examples and Embodiments

The presently disclosed subject matter now will be described and discussed in more detail in terms of some specific embodiments and examples with reference to the accompanying drawings, in which some, but not all embodiments of the invention are shown. Like numbers refer to like elements or parts throughout unless otherwise referenced. The presently disclosed subject matter may be embodied in many different forms and should not be construed as limited to the specific embodiments set forth herein. Rather, these embodiments are provided so that this disclosure will satisfy applicable legal requirements. Indeed, many modifications and other embodiments of the presently disclosed subject matter will come to the mind of one skilled in the art to which the presently disclosed subject matter pertains. Therefore, it is to be understood that the presently disclosed subject matter is not to be limited to the specific embodiments disclosed and that modifications and other embodiments are intended to be included within the scope of the appended claims.

### Definitions

### Interpretation of Terms and Words

The terms and words used in this specification and claims should not be interpreted as being limited to conventional or dictionary meanings, but should be interpreted based on the principle that the inventor can appropriately define the concepts of terms to best explain his invention, in accordance with the technical spirit of the present invention.

### “A,” “An” and “The”

As used herein, the singular form of a word includes the plural, unless the context clearly dictates otherwise. The plural encompasses the singular and vice versa. Thus, the references “a,” “an” and “the” are generally inclusive of the plurals of the respective terms. For example, while the present disclosure has been described in terms of “a” layer, “a” substrate, “a” cell, and the like, more than one of these and other components, including combinations, can be used.

### “About”

The term “about” indicates and encompasses an indicated value and a range above and below that value.

### “Include,” “Comprise,” or “Have”

In this specification, terms such as “include,” “comprise,” or “have” are intended to specify the presence of features, numbers, steps, components, or combinations thereof, and should be understood as not precluding the possibility of the presence or addition of one or more other features, numbers, steps, components, or combinations thereof.

“Comprise,” “Consisting Essentially of”, and “Consisting of”

The words “comprise,” “comprises,” and “comprising” are to be interpreted inclusively rather than exclusively. Likewise, the terms “include,” “including” and “or” should all be construed to be inclusive, unless such a construction is clearly prohibited from the context. A disclosure of an embodiment defined using the term “comprising” is also a disclosure of embodiments “consisting essentially of” and “consisting of” the disclosed components. The phrase “consisting of” excludes any element, step, or ingredient not specified.

### “And/Or”

The term “and/or” used in the context of “X and/or Y” should be interpreted as “X,” “Y,” or “X and Y.”

### “Volume %”

In this specification, “volume %” refers to the volume content based on the total volume of the composition, while “weight %” refers to the weight content or mass content based on the total weight or mass of the composition.

### Markush Group

As used herein, the term “combination thereof” included in any Markush-type expression means a combination or mixture of one or more elements selected from the group of elements disclosed in the Markush-type expression, and refers to the presence of one or more elements selected from the group. The term “combinations thereof” includes every possible combination of elements to which the term refers.

### “Between”

As used herein, the expression “between” is inclusive of end points.

### Numerical Ranges

Furthermore, all numerical ranges herein should be understood to include all integers, whole or fractions, within the range. Moreover, any numerical range recited herein is intended to include all sub-ranges subsumed therein, and these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth. When ranges are given, any endpoints of those ranges and/or numbers within those ranges can be combined with the scope of the present disclosure.

“*”

Meanwhile, unless otherwise specified in the present invention, “*” means the connected part (bonding site) between the same or different atoms or chemical formulas.

“Carbon “Including,” “Such as” and “for Example”

As used herein, “including,” “such as,” “for example,” and like terms mean “including/such as/for example but not limited to.”

“Carbon Number A To B”

As used herein, “carbon number a to b” refers to the number of carbon atoms included in the specific functional group. That is, the functional group can include “a” to “b” carbon atoms. For example, “alkyl group with 1 to 5 carbon atoms” refers to an alkyl group containing 1 to 5 carbon atoms, such as CH3-, CH3CH2-, CH3CH2CH2-, (CH3)2CH—, CH3CH2CH2CH2-, (CH3)2CHCH2-, CH3CH2CH2CH2CH2-, (CH3)2CHCH2CH2-, etc.

### “Alkyl”

In this specification, the term “alkyl” refers to a saturated aliphatic radical including straight-chain alkyl groups and branched-chain alkyl groups. The terms “alkenyl” and “alkynyl” are similar to alkyl groups but refer to unsaturated aliphatic groups containing at least one double or triple bond, respectively. The term “aryl” refers to aromatic hydrocarbon radicals having a single ring (e.g., phenyl), multiple rings (e.g., biphenyl), or multiple fused rings with at least one aromatic ring (e.g., naphthyl, 1,2,3,4-tetrahydronaphthyl). The terms “alkoxy” and “aryloxy” refer to alkyl and aryl groups having one oxygen atom. The term “heteroaryl” refers to aryl groups containing heteroatoms such as N, O, and S, but not limited to these.

### Alkyl Groups or Aryl Groups

In this specification, alkyl groups or aryl groups can be substituted or unsubstituted. The term “substitution” means that at least one hydrogen bonded to carbon is replaced with an element other than hydrogen, unless otherwise defined. For example, it refers to substitution with alkyl groups having 1 to 20 carbon atoms, alkenyl groups having 2 to 20 carbon atoms, alkynyl groups having 2 to 20 carbon atoms, alkoxy groups having 1 to 20 carbon atoms, cycloalkyl groups having 3 to 12 carbon atoms, heterocycloalkyl groups having 3 to 12 carbon atoms, aryloxy groups having 6 to 12 carbon atoms, halogen atoms, fluoroalkyl groups having 1 to 20 carbon atoms, nitro groups, aryl groups having 6 to 20 carbon atoms, heteroaryl groups having 2 to 20 carbon atoms, haloaryl groups having 6 to 20 carbon atoms, etc.

### Combination of Embodiments

As used herein, the term “example,” particularly when followed by a listing of terms, is merely illustrative, and should not be deemed to be exclusive or comprehensive. Any embodiment disclosed herein can be combined with any other embodiment disclosed herein unless explicitly indicated otherwise.

### Non-Aqueous Electrolyte

### Non-Aqueous Electrolyte Composition

The present disclosure provides a non-aqueous electrolyte for lithium ion batteries. The non-aqueous electrolyte includes at least one lithium salt and an organic solvent. The non-aqueous electrolyte may further include at least one additive.

### Organic Solvent

The organic solvent for the non-aqueous electrolyte includes one or more sulfonamide-based compounds with specific structures in a specific amount. The organic solvent may include one or more cyclic carbonate compounds and further include one or more linear carbonate compounds. The organic solvent may also additionally include one or more non-carbonate compounds. The organic solvent is discussed in more detail later.

### Lithium Salt

The lithium salt for the non-aqueous electrolyte can be any lithium salt commonly used in non-aqueous electrolytes for lithium secondary batteries without limitation. For example, the lithium salt can include Li+ as the cation and any of F−, Cl−, Br−, I−, NO3−, N(CN)2−, BF4−, ClO4−, AlO2−, AlO4−, AlCl4−, PF6−, SbF6−, AsF6−, B10Cl10−, BF2C2O4−, BC4O8−, PF4C2O4−, PF2C4O8−, (CF3)2PF4−, (CF3)3PF3−, (CF3)4PF2−, (CF3)5PF−, (CF3)6P−, CF3SO3−, C4F9SO3−, CF3CF2SO3−, (FSO2)2N−, CF3CF2(CF3)2CO−, (CF3SO2)2CH−, CH3SO3−, CF3(CF2) 7SO3−, CF3CO2−, CH3CO2−, SCN−, or (CF3CF2SO2)2N− as the anion.

### Examples of Lithium Salt

For example, the lithium salt can include at least one selected from the group consisting of LiCl, LiBr, LiI, LiBF4, LiClO4, LiAlO2, LiAlO4, LiAlCl4, LiPF6, LiSbF6, LiAsF6, LiB10Cl10, LiBOB (LiB(C2O4)2), LiCF3SO3, LiFSI (LiN(SO2F)2), LiCH3SO3, LiCF3CO2, LiCH3CO2, and LiBETI (LiN(SO2CF2CF3)2). In some embodiments, the lithium salt can include at least one selected from the group consisting of LiBF4, LiClO4, LiPF6, LiBOB (LiB(C2O4)2), LiCF3SO3, LiTFSI (LiN(SO2CF3)2), LiFSI (LiN(SO2F)2), and LiBETI (LiN(SO2CF2CF3)2). In some embodiments, the lithium salt includes LiPF6.

### Concentration of Lithium Salt

The lithium salt can be included in the non-aqueous electrolyte at a concentration at or about 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 7, 8, 9, or 10 M, etc. In embodiments, the concentration of the lithium salt can be within a range formed by selecting any two numbers in the preceding sentence, such as from about 0.5 to about 5, from about 0.8 to about 4, and from about 0.8 to 2.0 M, etc.

### Additives

The additives for the non-aqueous electrolyte can include at least one selected from the group consisting of lithium difluorophosphate (LiDFP), vinylene carbonate, vinyl ethylene carbonate, fluoroethylene carbonate, propane sultone, propene sultone, succinonitrile, adiponitrile, ethylene sulfate, lithium bis(oxalato)borate (LiBOB), lithium tetrafluoroborate (LiBF4), lithium difluoro (oxalato)borate (LiDFOB), lithium difluoro bis(oxalato) phosphate (LiDFOP), tris(trimethylsilyl) phosphate (TMSPa), tris(trimethylsilyl) phosphite (TMSPi), and compounds represented by the following Chemical Formula 2, although not limited thereto.

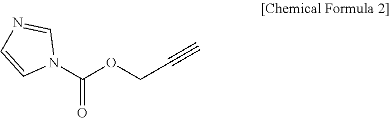

The non-aqueous electrolyte can include one or more additives in a total amount of 0.1% to 15% by weight, more specifically 0.3% to 10% by weight, relative to the total weight of the non-aqueous electrolyte.

### Viscosity of the Non-Aqueous Electrolyte

The non-aqueous electrolyte can have a viscosity at or about 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.6, 6.7, 6.8, 6.9, or 7 cP, etc at 25° C. In embodiments, the viscosity of the non-aqueous electrolyte may be within a range formed by any two numbers in the immediately preceding sentence, such as from about 2 to about 2 cP or more, 2.2 cP or more, 2.4 cP or more, 2.6 cP or more, 2.8 cP or more, 3 cP or more, 3.1 cP or more, 3.2 cP or more, 3.4 cP or more, or 3.5 cP or more. The viscosity of the non-aqueous electrolyte at 25° C. can be 6 cP or less, 5 cP or less, 4.5 cP or less, 4.2 cP or less, or 4 cP or less. The viscosity can be measured using a viscometer (BrookField, model: DV-3 ULTRA), for example, under the conditions of 25° C. and 250 RPM.

### Organic Solvent

### Organic Solvent-Sulfonamide and Cyclic Carbonate

The organic solvent for the non-aqueous electrolyte provided herein includes one or more sulfonamide compounds and one or more cyclic carbonate compounds. In some embodiments, the organic solvent consists essentially of one or more sulfonamide compounds and one or more cyclic carbonate compounds. In some embodiments, the organic solvent consists of one or more sulfonamide compounds and one or more cyclic carbonate compounds. Accordingly, the sum of the one or more sulfonamide compounds and the one or more cyclic carbonate compounds constitute all or substantially all of the organic solvent.

### Organic Solvent—Further Including Linear Carbonate

The organic solvent may further include one or more linear carbonate compounds. In some embodiments, the organic solvent consists essentially of one or more sulfonamide compounds, one or more cyclic carbonate compounds, and one or more linear carbonate compounds. In some embodiments, the organic solvent consists of one or more sulfonamide compounds, one or more cyclic carbonate compounds, and one or more linear carbonate compounds. Accordingly, the sum of the one or more sulfonamide compounds, the one or more cyclic carbonate compounds, and the one or more linear carbonate compounds constitute all or substantially all of the organic solvent.

### Organic Solvent—Further Including Non-Carbonate Compounds

The organic solvent may further include one or more non-carbonate compounds. In some embodiments, the organic solvent consists essentially of one or more sulfonamide compounds, one or more cyclic carbonate compounds, one or more linear carbonate compounds, and one or more non-carbonate compounds. In some embodiments, the organic solvent consists of one or more sulfonamide compounds, one or more cyclic carbonate compounds, one or more linear carbonate compounds, and one or more non-carbonate compounds. Accordingly, the sum of the one or more sulfonamide compounds, the one or more cyclic carbonate compounds, the one or more linear carbonate compounds, and one or more non-carbonate compounds constitute all or substantially all of the organic solvent.

### Sulfonamide Compound Organic Solvent

The organic solvent in the non-aqueous electrolyte includes one or more sulfonamide compounds represented by the following Chemical Formula 1:

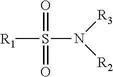

wherein R1 is a fluorine atom, an alkyl group having 1 to 10 carbon atoms substituted with one or more fluorines, or an alkoxy group having 1 to 10 carbon atoms substituted with one or more fluorines; and R2 and R3 are independently hydrogen, alkyl groups with 1 to 10 carbon atoms, or aryl groups with 6 to 20 carbon atoms.

### R2 and R3—H or Alkyl Group

Each of R2 and R3 can be independently any of H, Methyl (CH₃—), Ethyl (CH₃CH₂—), Propyl (CH₃CH₂CH₂—), Isopropyl ((CH₃)₂CH—), n-Butyl (CH₃CH₂CH₂CH₂—), Isobutyl ((CH₃)₂CHCH₂—), sec-Butyl (CH₃CH₂CH(CH₃)—), tert-Butyl ((CH₃)₃C—), n-Pentyl (CH₃(CH₂)₄—), Isopentyl (3-methylbutyl, (CH₃)₂CHCH₂CH₂—), Neopentyl (2,2-dimethylpropyl, (CH₃)₃CCH₂—), sec-Pentyl (CH₃CH₂CH(CH₂CH₃)—), tert-Pentyl (CH₃C(CH₃)₂CH₂—), 2-Methylbutyl (CH₃CH(CH₃)CH₂CH₂—), 1-Methylbutyl (CH₃CH₂CH₂CH(CH₃)—), 3-Methylbutyl (CH₃CH₂CH(CH₃)CH₂—), n-Hexyl (CH₃(CH₂)₅—), 1-Methylpentyl (CH₃CH₂CH₂CH(CH₃)CH₂—), 2-Methylpentyl (CH₃CH(CH₃)CH₂CH₂CH₂—), 3-Methylpentyl (CH₃CH₂CH(CH₃)CH₂CH₂—), 4-Methylpentyl (CH₃CH₂CH₂CH(CH₃)CH₂—), 2,2-Dimethylbutyl ((CH₃)₂CHCH₂CH₂CH₂—), 3,3-Dimethylbutyl (CH₃CH₂C(CH₃) 2CH₂—), 2,3-Dimethylbutyl (CH₃CH(CH₃)CH(CH₃)CH₂—), 2,4-Dimethylbutyl (CH₃CH(CH₃)CH₂CH(CH₃)—), 3,4-Dimethylbutyl (CH₃CH₂CH(CH₃)CH(CH₃)—), 3-Ethylbutyl (CH₃CH₂CH(CH₂CH₃)CH₂—), 2-Ethylbutyl (CH₃CH(CH₂CH₃)CH₂CH₂—), Isopentylmethyl ((CH₃)₂CHCH₂CH₂CH₂—), Neohexyl ((CH₃)₃CCH₂CH₂—), Isohexyl ((CH₃)₂CHCH₂CH₂CH₂—), 3-Methyl-2-pentyl (CH₃CH(CH₂CH₃)CH(CH₃)—), 2,2,2-Trimethylpropyl ((CH₃)₃CCH₂CH₃—), n-Heptyl (CH₃(CH₂)₆—), 1-Methylhexyl (CH₃CH₂CH₂CH₂CH(CH₃)CH₂—), 2-Methylhexyl (CH₃CH(CH₃)CH₂CH₂CH₂CH₂—), 3-Methylhexyl (CH₃CH₂CH(CH₃)CH₂CH₂CH₂—), 4-Methylhexyl (CH₃CH₂CH₂CH(CH₃)CH₂CH₂—), 5-Methylhexyl (CH₃CH₂CH₂CH₂CH(CH₃)CH₂—), 3-Ethylpentyl (CH₃CH₂CH(CH₂CH₃)CH₂CH₂—), 2-Ethylpentyl (CH₃CH(CH₂CH₃)CH₂CH₂CH₂—), 2,2-Dimethylpentyl) (CH₃)₂CHCH₂CH₂CH₂CH₂—), 2,3-Dimethylpentyl (CH₃CH(CH₃)CH(CH₃)CH₂CH₂—), 2,4-Dimethylpentyl-(CH₃CH(CH₃)CH₂CH(CH₃)CH₂—), 3,3-Dimethylpentyl (CH₃CH₂C(CH₃)₂CH₂CH₂—), 3,4-Dimethylpentyl (CH₃CH₂CH(CH₃)CH(CH₃)CH₂—), 3,5-Dimethylpentyl (CH₃CH₂CH(CH₃)CH₂CH(CH₃)—), 4,4-Dimethylpentyl (CH₃CH₂CH₂C(CH₃) 2CH₂—), 4,5-Dimethylpentyl (CH₃CH₂CH₂CH(CH₃)CH(CH₃)—), 3-Ethyl-2-methylbutyl (CH₃CH(CH₂CH₃)CH(CH₃)CH₂—), Neopentylpropyl ((CH₃)₃CCH₂CH₂CH₂—), Isohexylmethyl ((CH₃)₂CHCH₂CH₂CH₂CH₂—), 2-Methyl-3-ethylbutyl (CH₃CH(CH₃)CH(CH₂CH₃)CH₂—), 2-Propylpentyl (CH₃CH₂CH(CH₂CH₂CH₃)CH₂—), 3-Isopropylbutyl (CH₃CH₂CH(CH(CH₃)₂)CH₂—), 4-Isopropylbutyl (CH₃CH₂CH₂CH(CH(CH₃)₂)—), other isomers of C-His, n-Octyl (CH₃(CH₂)₇—), 1-Methylheptyl (CH₃CH₂CH₂CH₂CH₂CH(CH₃)CH₂—), 2-Methylheptyl (CH₃CH(CH₃)CH₂CH₂CH₂CH₂CH₂—), 3-Methylheptyl (CH₃CH₂CH(CH₃)CH₂CH₂CH₂CH₂—), 4-Methylheptyl (CH₃CH₂CH₂CH(CH₃)CH₂CH₂CH₂—), 2,2-Dimethylhexyl ((CH₃)₂CHCH₂CH₂CH₂CH₂CH₂—), 3,3-Dimethylhexyl (CH₃CH₂C(CH₃)₂CH₂CH₂CH₂—), 2-Ethylhexyl (CH₃CH(CH₂CH₃)CH₂CH₂CH₂CH₂—), 3-Ethylhexyl (CH₃CH₂CH(CH₂CH₃)CH₂CH₂CH₂—), Isooctyl ((CH₃)₂CHCH₂CH₂CH₂CH₂CH₂—), other isomers of C₈H₁₇, n-Nonyl (CH₃(CH₂)₈—), 1-Methyloctyl (CH₃CH₂CH₂CH₂CH₂CH₂CH(CH₃)CH₂—), 2-Methyloctyl (CH₃CH(CH₃)CH₂CH₂CH₂CH₂CH₂CH₂—), 3-Ethyloctyl (CH₃CH₂CH(CH₂CH₃)CH₂CH₂CH₂CH₂—), 2,2-Dimethylheptyl ((CH₃)₂CHCH₂CH₂CH₂CH₂CH₂CH₂—), other isomers of C₉H₁₉, n-Decyl (CH₃(CH₂)₉—), 1-Methylnonyl (CH₃CH₂CH₂CH₂CH₂CH₂CH₂CH(CH₃)CH₂—), 2-Ethyloctyl (CH₃CH(CH₂CH₃)CH₂CH₂CH₂CH₂CH₂CH₂—), 3,3-Dimethyloctyl (CH₃CH₂C(CH₃)₂CH₂CH₂CH₂CH₂CH₂—), or other isomers of C₁₀H₂₁.

### Examples of R2 and R3—Alkyl Group

For example, R2 and R3 can be independently an alkyl group with 1 to 10 carbon atoms, more specifically alkyl groups with 1 to 5 carbon atoms, and even more specifically alkyl groups with 1 to 3 carbon atoms. In some embodiments, R2 and R3 can be independently any of methyl, ethyl, or propyl groups, for example, one of methyl or ethyl groups. In one embodiment, each of R2 and R3 is a methyl group.

### Examples of R2 and R3—Aryl Group

Each of R2 and R3 can be independently any aryl group with 6 to 20 carbon atoms, including but not limited to, phenyl, tolyl, xylyl, cymyl, mesityl, indenyl, biphenyl, acoryl, naphthyl, phenanthryl, anthracyl, pyrenyl, chrysyl, perylenyl, and/or any of the following:

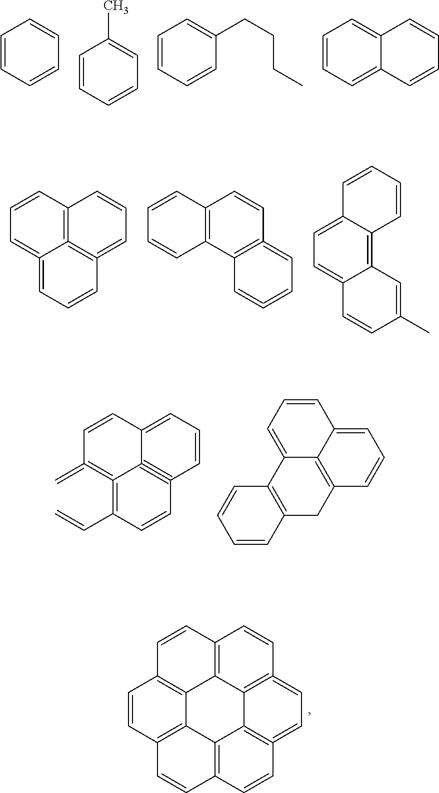

among others.

### R1—Fluorine

In some embodiments, R1 is a fluorine atom. The sulfonamide compound is represented by Chemical Formula 1-1:

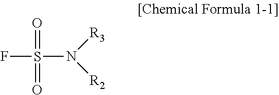

Example Sulfonamide Compounds—R1 being Fluorine

For example, the compound represented by Chemical Formula 1-1 can include at least one of N-methylfluorosulfonamide (F—SO₂—NHCH₃), N,N-dimethylfluorosulfonamide (F—SO₂—N(CH₃)₂), N-ethyl-N-methylfluorosulfonamide (F—SO₂—N(C₂H₅)(CH₃)), N-butylfluorosulfonamide (F—SO₂—N(C₄H₉)(H)), N-hexyl-N-propylfluorosulfonamide (F—SO₂—N(C₆H₁₃)(C₃H₇)), among others. For example, the compound represented by Chemical Formula 1-1 can include at least one compound represented by any of the following:

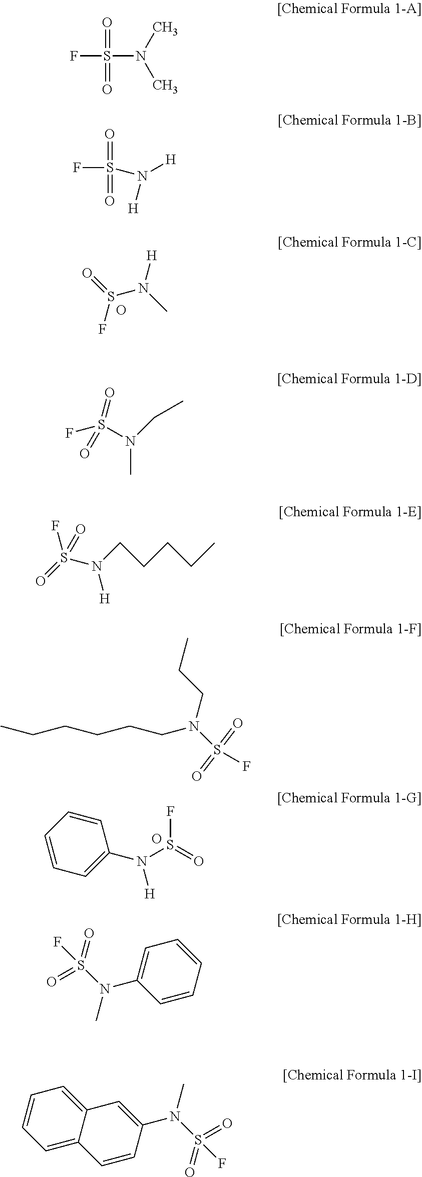

### R1—Alkoxy Group

In some embodiments, R1 is an alkoxy group having 1 to 10 carbon atoms substituted with one or more fluorines, for example, an alkoxy group having 1 to 5 carbon atoms substituted with one or more fluorines, or an alkoxy group having 1 to 3 carbon atoms substituted with one or more fluorines. In some embodiments, R1 is a fully fluorinated alkoxy group having 1 to 10 carbon atoms, for example, a fully fluorinated alkoxy group having 1 to 5 carbon atoms or a fully fluorinated alkoxy group having 1 to 3 carbon atoms. In one embodiment, R1 is CF₃O—*.

### Examples of Alkoxy Group

The alkoxy group having 1 to 10 carbon atoms may be any of Methoxy (—O—CH₃), Ethoxy (—O—CH₂CH₃), n-Propoxy (—O—CH₂CH₂CH₃), Isopropoxy (—O—CH(CH₃)₂), n-Butoxy (—O—CH₂CH₂CH₂CH₃), sec-Butoxy (—O—CH(CH₃)CH₂CH₃), isobutoxy (—O—CH₂CH(CH₃)₂), tert-Butoxy (—O—C(CH₃)₃), n-Pentoxy (—O—CH₂CH₂CH₂CH₂CH₃), 2-Methylbutoxy (—O—CH₂CH(CH₃)CH₂CH₃), 3-Methylbutoxy (—O—CH₂CH₂CH(CH₃)CH₃), Isopentoxy (—O—CH₂CH₂CH(CH₃) 2), Neopentoxy (—O—C(CH₃) 3CH₂), tert-Pentoxy (—O—CH(CH₃) C(CH₃) 2), n-Hexoxy (—O(CH₂)₅CH₃), 2-Methylpentoxy, 3-Methylpentoxy, other branched isomers of n-Hexoxy (e.g., isohexoxy, neohexoxy, etc), n-Heptoxy (—O(CH₂)₆CH₃), branched isomers of n-Heptoxy (e.g., 3-methylhexoxy, 4-methylhexoxy etc), n-Octoxy (—O(CH₂)₇CH₃) and branched isomers thereof (e.g., iso-octoxy, 2-ethylhexoxy, etc.), n-Nonoxy (—O(CH₂)₈CH₃) and branched isomers thereof (e.g., methyl-nonoxy, ethyl-octoxy, etc.), n-Decoxy (—O(CH₂)₉CH₃) and branched isomers thereof (e.g., 2-methylnonoxy, 3-ethyloctoxy, etc.), or any other isomers of the alkoxy group having 1 to 10 carbon atoms that are not specifically listed herein. R1 may be any of these alkoxy group substituted with one or more fluorine atoms.

### Examples of Fully Fluorinated Alkoxy Groups

Non-limiting examples of fully fluorinated alkoxy groups include, but are not limited to, Trifluoromethoxy (CF₃O—), Pentafluoroethoxy (C₂F₅O—), Heptafluoropropoxy (C₃F—O—), Nonafluorobutoxy (C₄F₉O—), Undecafluorohexoxy (C₆F₁₃O—), etc.

Example Sulfonamide Compounds—R1 being Fluorinated Alkoxy

For example, the compound represented by Chemical Formula 1 can include at least one of Trifluoromethoxyfluorosulfonamide (CF₃O—SO₂—NH₂), N-methyl-N-ethyl-pentafluoroethoxy sulfonamide (C₂F₅O—SO₂—N(CH₃)(C₂H₅)), N-methyl-N-phenyl-heptafluoropropoxy sulfonamide (C₃F—O—SO₂—N(C₆H₅)(CH₃)), N-phenyl-nonafluorobutoxy sulfonamide (C₄F₁₃O—SO₂—N(H)(C₆H₅)), N-naphthyl-N-ethyl-undecafluorohexoxy sulfonamide (C₆F₁₃O—SO₂—N(C₁₀H₇)(C₂H₅), among others. For example, the compound represented by Chemical Formula 1 can include at least one compound represented by any of the following:

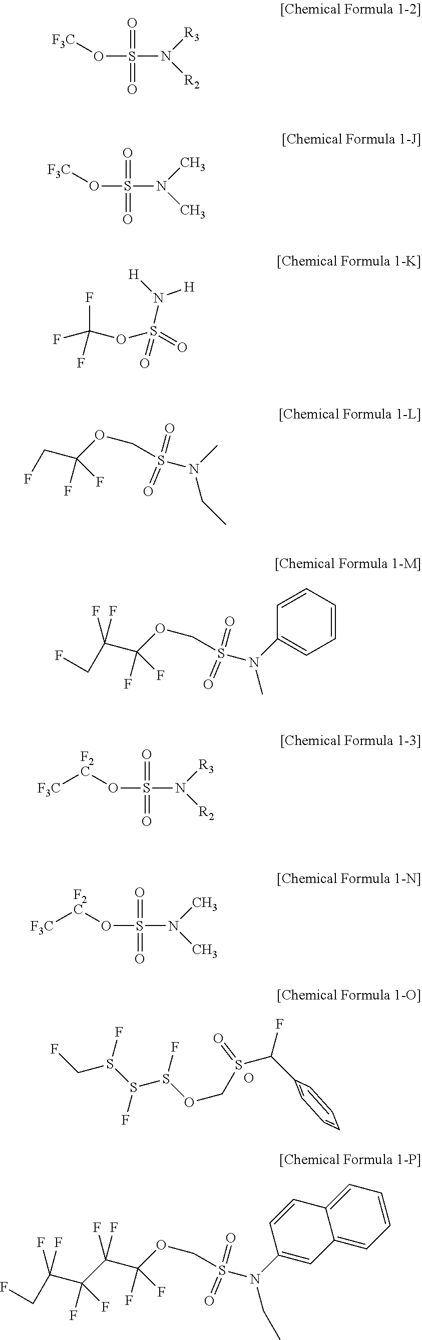

### R1—Alkyl Group

In some embodiments, R1 is an alkyl group having 1 to 10 carbon atoms substituted with one or more fluorines, for example, an alkyl group having 1 to 5 carbon atoms substituted with one or more fluorines, or an alkyl group having 1 to 3 carbon atoms substituted with one or more fluorines. In some embodiments, R1 is a fully fluorinated alkyl group having 1 to 10 carbon atoms, for example, a fully fluorinated alkyl group having 1 to 5 carbon atoms or a fully fluorinated alkyl group having 1 to 3 carbon atoms. In one embodiment, R1 is CF₃—*.

### Examples of Alkyl Group

The alkyl group having 1 to 10 carbon atoms may be any of Methyl (CH₃—), Ethyl (CH₃CH₂—), Propyl (CH₃CH₂CH₂—), Isopropyl ((CH₃)₂CH—), n-Butyl (CH₃CH₂CH₂CH₂—), Isobutyl ((CH₃)₂CHCH₂—), sec-Butyl (CH₃CH₂CH(CH₃)—), tert-Butyl ((CH₃) 3C—), n-Pentyl (CH₃(CH₂)₄—), Isopentyl (3-methylbutyl, (CH₃)₂CHCH₂CH₂—), Neopentyl (2,2-dimethylpropyl, (CH₃)₃CCH₂—), sec-Pentyl (CH₃CH₂CH(CH₂CH₃)—), tert-Pentyl (CH₃C(CH₃)₂CH₂—), 2-Methylbutyl (CH₃CH(CH₃)CH₂CH₂—), 1-Methylbutyl (CH₃CH₂CH₂CH(CH₃)—), 3-Methylbutyl (CH₃CH₂CH(CH₃)CH₂—), n-Hexyl (CH₃(CH₂)₅—), 1-Methylpentyl (CH₃CH₂CH₂CH(CH₃)CH₂—), 2-Methylpentyl (CH₃CH(CH₃)CH₂CH₂CH₂—), 3-Methylpentyl (CH₃CH₂CH(CH₃)CH₂CH₂—), 4-Methylpentyl (CH₃CH₂CH₂CH(CH₃)CH₂—), 2,2-Dimethylbutyl ((CH₃)₂CHCH₂CH₂CH₂—), 3,3-Dimethylbutyl (CH₃CH₂C(CH₃)₂CH₂—), 2,3-Dimethylbutyl (CH₃CH(CH₃)CH(CH₃)CH₂—), 2,4-Dimethylbutyl (CH₃CH(CH₃)CH₂CH(CH₃)—), 3,4-Dimethylbutyl (CH₃CH₂CH(CH₃)CH(CH₃)—), 3-Ethylbutyl (CH₃CH₂CH(CH₂CH₃)CH₂—), 2-Ethylbutyl (CH₃CH(CH₂CH₃)CH₂CH₂—), Isopentylmethyl ((CH₃)₂CHCH₂CH₂CH₂—), Neohexyl ((CH₃)₃CCH₂CH₂—), Isohexyl ((CH₃)₂CHCH₂CH₂CH₂—), 3-Methyl-2-pentyl (CH₃CH(CH₂CH₃)CH(CH₃)—), 2,2,2-Trimethylpropyl ((CH₃)₃CCH₂CH₃—), n-Heptyl (CH₃(CH₂)₆—), 1-Methylhexyl (CH₃CH₂CH₂CH₂CH(CH₃)CH₂—), 2-Methylhexyl (CH₃CH(CH₃)CH₂CH₂CH₂CH₂—), 3-Methylhexyl (CH₃CH₂CH(CH₃)CH₂CH₂CH₂—), 4-Methylhexyl (CH₃CH₂CH₂CH(CH₃)CH₂CH₂—), 5-Methylhexyl (CH₃CH₂CH₂CH₂CH(CH₃)CH₂—), 3-Ethylpentyl (CH₃CH₂CH(CH₂CH₃)CH₂CH₂—), 2-Ethylpentyl (CH₃CH(CH₂CH₃)CH₂CH₂CH₂—), 2,2-Dimethylpentyl) (CH₃)₂CHCH₂CH₂CH₂CH₂—), 2,3-Dimethylpentyl (CH₃CH(CH₃)CH(CH₃)CH₂CH₂—), 2,4-Dimethylpentyl-(CH₃CH(CH₃)CH₂CH(CH₃)CH₂—), 3,3-Dimethylpentyl (CH₃CH₂C(CH₃)₂CH₂CH₂—), 3,4-Dimethylpentyl (CH₃CH₂CH(CH₃)CH(CH₃)CH₂—), 3,5-Dimethylpentyl (CH₃CH₂CH(CH₃)CH₂CH(CH₃)—), 4,4-Dimethylpentyl (CH₃CH₂CH₂C(CH₃)₂CH₂—), 4,5-Dimethylpentyl (CH₃CH₂CH₂CH(CH₃)CH(CH₃)—), 3-Ethyl-2-methylbutyl (CH₃CH(CH₂CH₃)CH(CH₃)CH₂—), Neopentylpropyl-((CH₃) 3CCH₂CH₂CH₂—), Isohexylmethyl ((CH₃)₂CHCH₂CH₂CH₂CH₂—), 2-Methyl-3-ethylbutyl (CH₃CH(CH₃)CH(CH₂CH₃)CH₂—), 2-Propylpentyl (CH₃CH₂CH(CH₂CH₂CH₃)CH₂—), 3-Isopropylbutyl (CH₃CH₂CH(CH(CH₃) 2)CH₂—), 4-Isopropylbutyl (CH₃CH₂CH₂CH(CH(CH₃)₂)—), other isomers of C₇H₁₅, n-Octyl (CH₃(CH₂)₇—), 1-Methylheptyl (CH₃CH₂CH₂CH₂CH₂CH(CH₃)CH₂—), 2-Methylheptyl (CH₃CH(CH₃)CH₂CH₂CH₂CH₂CH₂—), 3-Methylheptyl (CH₃CH₂CH(CH₃)CH₂CH₂CH₂CH₂—), 4-Methylheptyl (CH₃CH₂CH₂CH(CH₃)CH₂CH₂CH₂—), 2,2-Dimethylhexyl ((CH₃)₂CHCH₂CH₂CH₂CH₂CH₂—), 3,3-Dimethylhexyl (CH₃CH₂C(CH₃)₂CH₂CH₂CH₂—), 2-Ethylhexyl (CH₃CH(CH₂CH₃)CH₂CH₂CH₂CH₂—), 3-Ethylhexyl (CH₃CH₂CH(CH₂CH₃)CH₂CH₂CH₂—), Isooctyl ((CH₃)₂CHCH₂CH₂CH₂CH₂CH₂—), other isomers of C₈H₁₇, n-Nonyl (CH₃(CH₂)₈—), 1-Methyloctyl (CH₃CH₂CH₂CH₂CH₂CH₂CH(CH₃)CH₂—), 2-Methyloctyl (CH₃CH(CH₃)CH₂CH₂CH₂CH₂CH₂CH₂—), 3-Ethyloctyl (CH₃CH₂CH(CH₂CH₃)CH₂CH₂CH₂CH₂—), 2,2-Dimethylheptyl ((CH₃)₂CHCH₂CH₂CH₂CH₂CH₂CH₂—), other isomers of C₉H₁₉, n-Decyl (CH₃(CH₂)₉—), 1-Methylnonyl (CH₃CH₂CH₂CH₂CH₂CH₂CH₂CH(CH₃)CH₂—), 2-Ethyloctyl (CH₃CH(CH₂CH₃)CH₂CH₂CH₂CH₂CH₂CH₂—), 3,3-Dimethyloctyl (CH₃CH₂C(CH₃)₂CH₂CH₂CH₂CH₂CH₂—), or other isomers of C₁₀H₂₁. R1 may be any of these alkyl groups substituted with one or more fluorine atoms.

Example Sulfonamide Compounds—R1 being Fully Fluorinated Alkyl

For example, the compound represented by Chemical Formula 1 can include a compound represented by any of the following:

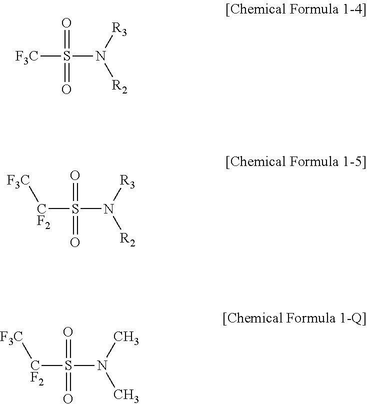

### One or More Sulfonamide Compounds

The organic solvent for the non-aqueous electrolyte can include one or more of the compounds represented by Chemical Formula 1. For example, the organic solvent may include one of more of the compounds represented by Chemical Formulas 1-1, 1-2, 1-3, 1-4, 1-5, 1-A, 1-B, 1-C, 1-D, 1-E, 1-F, 1-G, 1-H, 1-I, 1-J, 1-K, 1-L, 1-M, 1-N, 1-O, 1-P, and 1-Q as listed above, as well as any other compounds represented by Chemical Formula 1 but not specifically listed above.

### Amount of Sulfonamide Compound

In embodiments, the organic solvent can include one or more compounds represented by Chemical Formula 1 in an amount at or about 1, 2, 3, 4, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 9, 9.1, 9.2, 9.3, 9.4, 9.5, 9.6, 9.7, 9.8, 9.9, 10, 10.05, 10.1, 10.15, 10.2, 10.25, 10.3, 10.35, 10.4, 10.45, 10.5, 10.55, 10.6, 10.65, 10.7, 10.75, 10.8, 10.85, 10.9, 10.95, 11, 11.05, 11.1, 11.15, 11.2, 11.25, 11.3, 11.35, 11.4, 11.45, 11.5, 11.55, 11.6, 11.65, 11.7, 11.75, 11.8, 11.85, 11.9, 11.95, 12, 12.05, 12.1, 12.15, 12.2, 12.25, 12.3, 12.35, 12.4, 12.45, 12.5, 12.55, 12.6, 12.65, 12.7, 12.75, 12.8, 12.85, 12.9, 12.95, 13, 13.05, 13.1, 13.15, 13.2, 13.25, 13.3, 13.35, 13.4, 13.45, 13.5, 13.55, 13.6, 13.65, 13.7, 13.75, 13.8, 13.85, 13.9, 13.95, 14, 14.05, 14.1, 14.15, 14.2, 14.25, 14.3, 14.35, 14.5, 14.45, 14.6, 14.65, 14.7, 14.75, 14.8, 14.85, 14.9, 14.95, 15, 15.05, 15.1, 15.15, 15.2, 15.25, 15.3, 15.35, 15.4, 15.45, 15.5, 15.55, 15.6, 15.65, 15.7, 15.75, 15.8, 15.85, 15.9, 15.95, 16, 16.05, 16.1, 16.15, 16.2, 16.25, 16.3, 16.35, 16.4, 16.45, 16.5, 16.55, 16.6, 16.65, 16.7, 16.75, 16.8, 16.85, 16.9, 16.95, 17, 17.05, 17.1, 17.15, 17.2, 17.25, 17.3, 17.35, 17.4, 17.45, 17.5, 17.55, 17.6, 17.65, 17.7, 17.75, 17.8, 17.85, 17.9, 17.95, 18, 18.05, 18.1, 18.15, 18.2, 18.25, 18.3, 18.35, 18.4, 18.45, 18.5, 18.55, 18.6, 18.65, 18.7, 18.75, 18.8, 18.85, 18.9, 18.85, 19, 19.05, 19.1, 19.15, 19.2, 19.25, 19.3, 19.35, 19.4, 19.45, 19.5, 19.55, 19.6, 19.65, 19.7, 19.75, 19.8, 19.85, 19.9, 19.95, 20, 20.05, 20.1, 20.15, 20.2, 20.25, 20.3, 20.35, 20.4, 20.45, 20.5, 20.55, 20.6, 20.65, 20.7, 20.75, 20.8, 20.85, 20.9, 20.95, 21, 21.05, 21.1, 21.15, 21.2, 21.25, 21.3, 21.35, 21.4, 21.45, 21.5, 21.55, 21.6, 21.65, 21.7, 21.75, 21.8, 21.85, 21.9, 21.95, 22, 22.05, 22.1, 22.15, 22.2, 22.25, 22.3, 22.35, 22.4, 22.45, 22.5, 22.55, 22.6, 22.65, 22.7, 22.75, 22.8, 22.85, 22.9, 22.95, 23, 23.05, 23.1, 23.15, 23.2, 23.25, 23.3, 23.35, 23.4, 23.45, 23.5, 23.55, 23.6, 23.65, 23.7, 23.75, 23.8, 23.85, 23.9, 23.95, 24, 24.05, 24.1, 24.15, 24.2, 24.25, 24.3, 24.35, 24.4, 24.45, 24.5, 24.55, 24.6, 24.65, 24.7, 24.75, 24.8, 24.85, 24.9, 24.95, 25, 25.05, 25.1, 25.15, 25.2, 25.25, 25.3, 25.35, 25.4, 25.45, 25.5, 25.55, 25.6, 25.65, 25.7, 25.75, 25.8, 25.85, 25.9, 25.95, 26, 26.05, 26.1, 26.15, 26.2, 26.25, 26.3, 26.35, 26.4, 26.45, 26.5, 26.55, 26.6, 26.65, 26.7, 26.75, 26.8, 26.85, 26.9, 26.95, 27, 27.05, 27.1, 27.15, 27.2, 27.25, 27.3, 27.35, 27.4, 27.45, 27.5, 27.55, 27.6, 27.65, 27.7, 27.75, 27.8, 27.85, 27.9, 27.95, 28, 28.05, 28.1, 28.15, 28.2, 28.25, 28.3, 28.35, 28.4, 28.45, 28.5, 28.55, 28.6, 28.65, 28.7, 28.75, 28.8, 28.85, 28.9, 28.95, 29, 29.05, 29.1, 29.15, 29.2, 29.25, 29.3, 29.35, 29.4, 29.45, 29.5, 29.55, 29.6, 29.65, 29.7, 29.75, 29.8, 29.85, 29.9, 29.95, 30, 30.1, 30.2, 30.3, 30.4, 30.5, 30.6, 30.7, 30.8, 30.9, 31, 31.1, 31.2, 31.3, 31.4, 31.5, 31.6, 31.7, 31.8, 31.9, 32, 32.1, 32.2, 32.3, 32.4, 32.5, 32.6, 32.7, 32.8, 32.9, 33, 33.1, 33.2, 33.3, 33.4, 33.5, 33.6, 33.7, 33.8, 33.9, 34, 34.1, 34.2, 34.3, 34.3, 34.4, 34.5, 34.6, 34.7, 34.8, 34.9, 35, 35.1, 35.2, 35.3, 35.4, 35.5, 35.6, 35.7, 35.8, 35.9, 36, 36.1, 36.2, 36.3, 36.4, 36.5, 36.6, 36.7, 36.8, 36.9, 37, 37.1, 37.2, 37.3, 37.3, 37.4, 37.5, 37.6, 37.7, 37.8, 37.9, 38, 38.1, 38.2, 38.3, 38.4, 38.5, 38.6, 38.7, 38.8, 38.9, 39, 39.1, 39.2, 39.3, 39.4, 39.5, 39.6, 39.7, 39.8, 39.9, 40, 40.1, 40.2, 40.3, 40.4, 40.5, 40.6, 40.7, 40.8, 40.9, 41, 41.1, 41.2, 41.3, 41.4, 41.5, 41.6, 41.7, 41.8, 41.9, 42, 42.1, 42.2, 42.3, 42.4, 42.5, 42.6, 42.7, 42.8, 42.9, 43, 43.1, 43.2, 43.3, 43.4, 43.5, 43.6, 43.7, 43.8, 43.9, 44, 44.1, 44.2, 44.3, 44.4, 44.5, 44.6, 44.7, 44.8, 44.9, 45, 45.1, 45.2, 45.3, 45.4, 45.5, 45.6, 45.7, 45.8, 45.9, 46, 46.1, 46.2, 46.3, 46.4, 46.5, 46.6, 46.7, 46.8, 46.9, 47, 47.1, 47.2, 47.3, 47.4, 47.5, 47.6, 47.7, 47.8, 47.9, 48, 48.1, 48.2, 48.3, 48.4, 48.5, 48.6, 48.7, 48.8, 48.9, 49, 49.1, 49.2, 49.3, 49.4, 49.5, 49.6, 49.7, 49.8, 49.9, 50, 51, 52, 53, 54, 55, 56, 57, 58, 59, or 60% etc. by volume, relative to the total volume of the organic solvent. In embodiments, the volume percentage of the compound represented by Chemical Formula 1 may be within a range formed by any two numbers in the immediately preceding sentence, such as from about 5 to about 50, from about 5 to about 30, from about 10 to about 30, from about 10 to about 20, from about 15 to about 25, from about 18 to about 22, from about 10.5 to about 25.5, from about 18.8 to about 22.4, from about 11.6 to about 30.2, from about 19.1 to about 20.7%, etc. by volume, relative to the total volume of the organic solvent. Each amount provided in this paragraph means the total amount of the one or more compounds represented by Chemical Formula 1 in the organic solvent.

### Cyclic Carbonate Organic Solvent

### Cyclic Carbonate

The organic solvent in the non-aqueous electrolyte includes one or more cyclic carbonate compounds with or without carbon-carbon unsaturated bond. Some of these cyclic carbonate compounds contain at least one halogen atom such as fluorine. Some others do not contain any halogen atom. In some embodiments, the organic solvent does not include any halogenated cyclic carbonate compound. In other embodiments, the organic solvent includes one or more halogenated cyclic carbonate compounds.

### Examples of Cyclic Carbonate

The cyclic carbonate includes, for example, a vinylene carbonate-based compound, a vinylethylene carbonate-based compound, a methylene ethylene carbonate-based compound, among others. The cyclic carbonate may have a halogen atom. The cyclic carbonate compound can include at least one of ethylene carbonate (EC), propylene carbonate (PC), vinylene carbonate (VC), methyl ethylene carbonate (MEC), 1,2-butylene carbonate, 2,3-butylene carbonate, 1,2-pentylene carbonate, 2,3-pentylene carbonate, or methyl vinylene carbonate, ethyl vinylene carbonate, 1,2-dimethyl vinylene carbonate, 1,2-diethyl vinylene carbonate, 1-ethyl-2-vinylethylene carbonate, 1-n-propyl-2-vinylethylene carbonate, 1-methyl-2-vinyl ethylene carbonate, 1,1-divinyl ethylene carbonate, 1,2-divinyl ethylene carbonate, 1,1-dimethyl-2-ethylene carbonate, 1,1-diethyl-2-methylene-ethylene carbonate, fluoroethylene carbonate, 1,2-difluoroethylene carbonate, 1,1-difluoroethylene carbonate, 1,1,2-trifluoroethylene carbonate, tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, trifluoromethylethylene, fluoro vinylene carbonate, and/or trifluoromethyl carbonate, among others.

### Ethylene Carbonate

In some embodiments, the organic solvent includes ethylene carbonate together with at least one sulfonamide compound. In some other embodiments, the organic solvent includes ethylene carbonate together with at least one sulfonamide compound and at least one linear carbonate compound. In some other embodiments, the organic solvent includes ethylene carbonate together with at least one sulfonamide compound, at least one linear carbonate compound, and at least one non-carbonate compound.

### Amount of Cyclic Carbonate

The organic solvent can include the cyclic carbonate in an amount at or about 1, 2, 3, 4, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 9, 9.1, 9.2, 9.3, 9.4, 9.5, 9.6, 9.7, 9.8, 9.9, 10, 10.05, 10.1, 10.15, 10.2, 10.25, 10.3, 10.35, 10.4, 10.45, 10.5, 10.55, 10.6, 10.65, 10.7, 10.75, 10.8, 10.85, 10.9, 10.95, 11, 11.05, 11.1, 11.15, 11.2, 11.25, 11.3, 11.35, 11.4, 11.45, 11.5, 11.55, 11.6, 11.65, 11.7, 11.75, 11.8, 11.85, 11.9, 11.95, 12, 12.05, 12.1, 12.15, 12.2, 12.25, 12.3, 12.35, 12.4, 12.45, 12.5, 12.55, 12.6, 12.65, 12.7, 12.75, 12.8, 12.85, 12.9, 12.95, 13, 13.05, 13.1, 13.15, 13.2, 13.25, 13.3, 13.35, 13.4, 13.45, 13.5, 13.55, 13.6, 13.65, 13.7, 13.75, 13.8, 13.85, 13.9, 13.95, 14, 14.05, 14.1, 14.15, 14.2, 14.25, 14.3, 14.35, 14.5, 14.45, 14.6, 14.65, 14.7, 14.75, 14.8, 14.85, 14.9, 14.95, 15, 15.05, 15.1, 15.15, 15.2, 15.25, 15.3, 15.35, 15.4, 15.45, 15.5, 15.55, 15.6, 15.65, 15.7, 15.75, 15.8, 15.85, 15.9, 15.95, 16, 16.05, 16.1, 16.15, 16.2, 16.25, 16.3, 16.35, 16.4, 16.45, 16.5, 16.55, 16.6, 16.65, 16.7, 16.75, 16.8, 16.85, 16.9, 16.95, 17, 17.05, 17.1, 17.15, 17.2, 17.25, 17.3, 17.35, 17.4, 17.45, 17.5, 17.55, 17.6, 17.65, 17.7, 17.75, 17.8, 17.85, 17.9, 17.95, 18, 18.05, 18.1, 18.15, 18.2, 18.25, 18.3, 18.35, 18.4, 18.45, 18.5, 18.55, 18.6, 18.65, 18.7, 18.75, 18.8, 18.85, 18.9, 18.85, 19, 19.05, 19.1, 19.15, 19.2, 19.25, 19.3, 19.35, 19.4, 19.45, 19.5, 19.55, 19.6, 19.65, 19.7, 19.75, 19.8, 19.85, 19.9, 19.95, 20, 20.05, 20.1, 20.15, 20.2, 20.25, 20.3, 20.35, 20.4, 20.45, 20.5, 20.55, 20.6, 20.65, 20.7, 20.75, 20.8, 20.85, 20.9, 20.95, 21, 21.05, 21.1, 21.15, 21.2, 21.25, 21.3, 21.35, 21.4, 21.45, 21.5, 21.55, 21.6, 21.65, 21.7, 21.75, 21.8, 21.85, 21.9, 21.95, 22, 22.05, 22.1, 22.15, 22.2, 22.25, 22.3, 22.35, 22.4, 22.45, 22.5, 22.55, 22.6, 22.65, 22.7, 22.75, 22.8, 22.85, 22.9, 22.95, 23, 23.05, 23.1, 23.15, 23.2, 23.25, 23.3, 23.35, 23.4, 23.45, 23.5, 23.55, 23.6, 23.65, 23.7, 23.75, 23.8, 23.85, 23.9, 23.95, 24, 24.05, 24.1, 24.15, 24.2, 24.25, 24.3, 24.35, 24.4, 24.45, 24.5, 24.55, 24.6, 24.65, 24.7, 24.75, 24.8, 24.85, 24.9, 24.95, 25, 25.05, 25.1, 25.15, 25.2, 25.25, 25.3, 25.35, 25.4, 25.45, 25.5, 25.55, 25.6, 25.65, 25.7, 25.75, 25.8, 25.85, 25.9, 25.95, 26, 26.05, 26.1, 26.15, 26.2, 26.25, 26.3, 26.35, 26.4, 26.45, 26.5, 26.55, 26.6, 26.65, 26.7, 26.75, 26.8, 26.85, 26.9, 26.95, 27, 27.05, 27.1, 27.15, 27.2, 27.25, 27.3, 27.35, 27.4, 27.45, 27.5, 27.55, 27.6, 27.65, 27.7, 27.75, 27.8, 27.85, 27.9, 27.95, 28, 28.05, 28.1, 28.15, 28.2, 28.25, 28.3, 28.35, 28.4, 28.45, 28.5, 28.55, 28.6, 28.65, 28.7, 28.75, 28.8, 28.85, 28.9, 28.95, 29, 29.05, 29.1, 29.15, 29.2, 29.25, 29.3, 29.35, 29.4, 29.45, 29.5, 29.55, 29.6, 29.65, 29.7, 29.75, 29.8, 29.85, 29.9, 29.95, 30, 30.1, 30.2, 30.3, 30.4, 30.5, 30.6, 30.7, 30.8, 30.9, 31, 31.1, 31.2, 31.3, 31.4, 31.5, 31.6, 31.7, 31.8, 31.9, 32, 32.1, 32.2, 32.3, 32.4, 32.5, 32.6, 32.7, 32.8, 32.9, 33, 33.1, 33.2, 33.3, 33.4, 33.5, 33.6, 33.7, 33.8, 33.9, 34, 34.1, 34.2, 34.3, 34.3, 34.4, 34.5, 34.6, 34.7, 34.8, 34.9, 35, 35.1, 35.2, 35.3, 35.4, 35.5, 35.6, 35.7, 35.8, 35.9, 36, 36.1, 36.2, 36.3, 36.4, 36.5, 36.6, 36.7, 36.8, 36.9, 37, 37.1, 37.2, 37.3, 37.3, 37.4, 37.5, 37.6, 37.7, 37.8, 37.9, 38, 38.1, 38.2, 38.3, 38.4, 38.5, 38.6, 38.7, 38.8, 38.9, 39, 39.1, 39.2, 39.3, 39.4, 39.5, 39.6, 39.7, 39.8, 39.9, 40, 40.1, 40.2, 40.3, 40.4, 40.5, 40.6, 40.7, 40.8, 40.9, 41, 41.1, 41.2, 41.3, 41.4, 41.5, 41.6, 41.7, 41.8, 41.9, 42, 42.1, 42.2, 42.3, 42.4, 42.5, 42.6, 42.7, 42.8, 42.9, 43, 43.1, 43.2, 43.3, 43.4, 43.5, 43.6, 43.7, 43.8, 43.9, 44, 44.1, 44.2, 44.3, 44.4, 44.5, 44.6, 44.7, 44.8, 44.9, 45, 45.1, 45.2, 45.3, 45.4, 45.5, 45.6, 45.7, 45.8, 45.9, 46, 46.1, 46.2, 46.3, 46.4, 46.5, 46.6, 46.7, 46.8, 46.9, 47, 47.1, 47.2, 47.3, 47.4, 47.5, 47.6, 47.7, 47.8, 47.9, 48, 48.1, 48.2, 48.3, 48.4, 48.5, 48.6, 48.7, 48.8, 48.9, 49, 49.1, 49.2, 49.3, 49.4, 49.5, 49.6, 49.7, 49.8, 49.9, 50, 51, 52, 53, 54, 55, 56, 57, 58, 59, or 60% etc. by volume, relative to the total volume of the organic solvent. In embodiments, the amount of the cyclic carbonate may be within a range formed by any two numbers in the immediately preceding sentence, such as from about 5 to about 50, from about 10 to about 50, from about 5 to about 30, from about 10 to about 30, from about 10 to about 20, from about 15 to about 25, from about 18 to about 22, from about 10.5 to about 25.5, from about 18.8 to about 22.4, from about 11.6 to about 30.2, from about 19.1 to about 20.7%, etc. by volume, relative to the total volume of the organic solvent. The amount provided in this paragraph may be the total amount of one or more cyclic carbonate compounds.

### Fluorine-Substituted Cyclic Carbonate

The organic solvent may include a fluorine-substituted cyclic carbonate in an amount at or about 0, 1, 2, 3, 4, 5, 6, 7, 8, 9, 10, 11, 12, 13, 14, 15, 16, 17, 18, 19, 20 vol %, relative to the total volume of the organic solvent. In embodiments, the amount of the fluorine-substituted cyclic carbonate may be within a range formed by any two numbers in the immediately preceding sentence, such as from about 0 to about 6, from about 1 to about 3, from about 0 to about 2, from about 2 to about 4, from about 3 to about 5, from about 4 to about 6, or from about 7 to about 10, etc.

### Linear Carbonate Organic Solvent

### Linear Carbonate

The organic solvent in the non-aqueous electrolyte may further include one or more linear carbonate compounds. The one or more linear carbonate compounds may include, but are not limited to, dimethyl carbonate (DMC), diethyl carbonate (DEC), dipropyl carbonate (DPC), ethyl methyl carbonate (EMC), methyl propyl carbonate (MPC), and ethyl propyl carbonate (EPC). In some embodiments, the organic solvent may include at least one linear carbonate compound selected from the group consisting of ethyl methyl carbonate (EMC), dimethyl carbonate (DMC), and diethyl carbonate (DEC).

### Amount of Linear Carbonate

When the organic solvent further includes linear carbonate, the organic solvent can include the linear carbonate in an amount at or about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90%, etc. by volume, relative to the total volume of the organic solvent. In embodiments, the amount of the linear carbonate may be within a range formed by any two numbers in the immediately preceding sentence, such as from about 25 to about 50, from about 20 to about 52, from about 35 to about 70, from about 28 to about 65, from about 40 to about 57, from about 22 to about 55, from about 68 to about 82, from about 52 to about 84, from about 48 to about 75% etc. by volume, relative to the total volume of the organic solvent. The amount provided in this paragraph may be the total amount of one or more linear carbonate compounds.

### Non-Carbonate Organic Solvent

### Non-Carbonate Organic Solvent

The organic solvent in the non-aqueous electrolyte may additionally include other non-carbonate compounds usually used in a non-aqueous electrolyte. For example, the organic solvent can further include at least one of linear ester-based organic solvents, cyclic ester-based organic solvents, ether-based organic solvents, glyme-based solvents, or nitrile-based organic solvents, etc.

### Linear Ester

The linear ester-based organic solvents can include at least one selected from the group consisting of methyl acetate, ethyl acetate, propyl acetate, methyl propionate, ethyl propionate, propyl propionate, and butyl propionate, although not limited thereto.

### Cyclic Ester

The cyclic ester-based organic solvents can include at least one selected from the group consisting of γ-butyrolactone, γ-valerolactone, γ-caprolactone, σ-valerolactone, and ε-caprolactone, although not limited thereto.

### Ether

The ether-based solvents can include at least one or a mixture of two or more selected from the group consisting of dimethyl ether, diethyl ether, dipropyl ether, methyl ethyl ether, methyl propyl ether, ethyl propyl ether, 1,3-dioxolane (DOL), and 2,2-bis(trifluoromethyl)-1,3-dioxolane (TFDOL), although not limited thereto.

### Glyme

The glyme-based solvents have higher dielectric constant and lower surface tension compared to linear carbonate-based organic solvents, and are solvents with low reactivity with metals. The glyme-based solvents may include at least one selected from the group consisting of dimethoxyethane (glyme, DME), diethoxyethane, diglyme, triglyme, and tetraglyme (TEGDME), although not limited thereto.

### Nitrile

The nitrile-based solvents can include at least one selected from the group consisting of acetonitrile, propionitrile, butyronitrile, valeronitrile, caprylonitrile, heptanonitrile, cyclopentane carbonitrile, cyclohexane carbonitrile, 2-fluorobenzonitrile, 4-fluorobenzonitrile, difluorobenzonitrile, trifluorobenzonitrile, phenylacetonitrile, 2-fluorophenylacetonitrile, and 4-fluorophenylacetonitrile, although not limited thereto.

### Relative Amounts of Organic Solvent Components

### Organic Solvent—Sulfonamide and Cyclic Carbonate

In embodiments of the organic solvents consisting essentially of or consisting of one or more sulfonamide compounds and one or more cyclic carbonate compounds, the total amount of the one or more sulfonamide compounds relative to the total volume of the organic solvent may be any amount listed in the paragraph with the heading “Amount of Sulfonamide Compound,” and the total amount of the one or more cyclic carbonate compounds is the remaining of the organic solvent. Accordingly, the sum of the one or more sulfonamide compounds and the one or more cyclic carbonate compounds constitute all or substantially all of the organic solvent.

### Organic Solvent—Further Including Linear Carbonate

In embodiments of the organic solvents consisting essentially of or consisting of one or more sulfonamide compounds, one or more cyclic carbonate compounds, and one or more linear carbonate compounds, the total amount of the one or more sulfonamide compounds relative to the total volume of the organic solvent may be any amount listed in the paragraph with the heading “Amount of Sulfonamide Compound,” the total amount of the one or more cyclic carbonate compounds relative to the total volume of the organic solvent may be any amount listed in the paragraph with the heading “Amount of Cyclic Carbonate,” and the total amount of the one or more linear carbonate compounds is the remaining of the organic solvent. Accordingly, the sum of the one or more sulfonamide compounds, the one or more cyclic carbonate compounds, and the one or more linear carbonate compounds constitute all or substantially all of the organic solvent.

### Organic Solvent—Further Including Non-Carbonate Compounds

In embodiments of the organic solvents consisting essentially of or consisting of one or more sulfonamide compounds, one or more cyclic carbonate compounds, one or more linear carbonate compounds, and one or more non-carbonate compounds, the total amount of the one or more sulfonamide compounds relative to the total volume of the organic solvent may be any amount listed in the paragraph with the heading “Amount of Sulfonamide Compound,” the total amount of the one or more cyclic carbonate compounds relative to the total volume of the organic solvent may be any amount listed in the paragraph with the heading “Amount of Cyclic Carbonate,” and the total amount of the one or more linear carbonate compounds may be any amount listed in the paragraph with the heading “Amount of Linear Carbonate,” and the total amount of the one or more non-carbonate compounds is the remaining of the organic solvent. Accordingly, the sum of the one or more sulfonamide compounds, the one or more cyclic carbonate compounds, the one or more linear carbonate compounds, and the one or more non-carbonate compounds constitute all or substantially all of the organic solvent.

### Volume Ratio of Sulfonamide Compound to Cyclic Carbonate

In some embodiments, the volume ratio of the compound represented by Chemical Formula 1 to the cyclic carbonate in the organic solvent may be at or about 0.2, 0.25, 0.3, 0.35, 0.4, 0.45, 0.5, 0.55, 0.6, 0.65, 0.7, 0.75, 0.8, 0.85, 0.9, 0.95, 1, 1.05, 1.1, 1.15, 1.2, 1.25, 1.3, 1.35, 1.4, 1.45, 1.5, 1.55, 1.6, 1.65, 1.7, 1.75, 1.8, 1.85, 1.9, 1.95, 2, 2.05, 2.1, 2.15, 2.2, 2.25, 2.3, 2.35, 2.4, 2.45, 2.5, 2.55, 2.6, 2.65, 2.7, 2.75, 2.8, 2.85, 2.9, 2.95, or 3. In embodiments, this volume ratio may be within a range formed by any two numbers in the immediately preceding sentence, for example, from about 0.2 to about 3.0, from about 0.5 to about 2.5, from about 1 to about 2, from about 1.5 to about 2.5, etc. This ratio may be the ratio of the total volume of one or more compounds represented by Chemical Formula 1 to the total volume of one or more cyclic carbonate compounds in the organic solvent. If this volume ratio is too low, the viscosity of the organic solvent could be too high. On the other hand, if this volume ratio is too high, the dissociation of the lithium salt could decrease.

### Volume Ratio of Sulfonamide Compound to Linear Carbonate

When the organic solvent further includes linear carbonate, in some embodiments, the ratio of the volume of the compound represented by Chemical Formula 1 to the volume of the linear carbonate in the organic solvent may be at or about 0.05, 0.06, 0.07, 0.08, 0.09, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.05, 1.1, 1.15, 1.2, 1.25, 1.3, 1.35, 1.4, 1.45, 1.5, 1.55, 1.6, 1.65, 1.7, 1.75, 1.8, 1.85, 1.9, 1.95, 2, 2.05, 2.1, 2.15, 2.2, 2.25, 2.3, 2.35, 2.4, 2.45, or 2.5. In embodiments, this volume ratio may be within a range formed by any two numbers in the immediately preceding sentence, for example, from about 0.2 to about 3.0, from about 0.5 to about 2.5, from about 1 to about 2, from about 1.5 to about 2.5, from about 0.05 to about 2, from about 0.05 to about 1.5, etc. This ratio may be the ratio of the total volume of one or more compounds represented by Chemical Formula 1 to the total volume of one or more linear carbonate compounds in the organic solvent.

### Volume Ratio of Cyclic Carbonate to Linear Carbonate

When the organic solvent further includes linear carbonate, in some embodiments, the ratio of the volume of the cyclic carbonate to the volume of the linear carbonate in the organic solvent may be at or about 0.3, 0.35, 0.4, 0.45, 0.5, 0.55, 0.6, 0.65, 0.7, 0.75, 0.8, 0.85, 0.9, 0.95, 1, 1.05, 1.1, 1.15, 1.2, 1.25, 1.3, 1.35, 1.4, 1.45, 1.5, 1.55, 1.6, 1.65, 1.7, 1.75, 1.8, 1.85, 1.9, 1.95, 2, 2.05, 2.1, 2.15, 2.2, 2.25, 2.3, 2.35, 2.4, 2.45, or 2.5. In embodiments, this volume ratio may be within a range formed by any two numbers in the immediately preceding sentence, for example, from about 0.3 to about 3.0, from about 0.3 to about 2.5, from about 0.5 to about 2.5, from about 1 to about 2, from about 1.5 to about 2.5, from about 0.25 to about 2.5, from about 1 to about 1.2, from about 0.95 to about 1.24, from about 0.9 to about 1.3, from about 0.8 to about 1.4, from about 0.7 to about 1.6, from about 0.6 to about 1.7, from about 0.5 to about 2.3, from about 35 to about 2.4, etc. This ratio may be the ratio of the total volume of one or more cyclic carbonate compounds to the total volume of one or more linear carbonate compounds in the organic solvent.

### Less Formation of Gas

### Effects

When the non-aqueous electrolyte is specifically formulated as described herein—including the tailored organic solvent system, particularly as recited in the claims—gas generation within the lithium secondary battery is significantly reduced compared to the conventional technology. This benefit is confirmed through extended use and storage of the battery under certain conditions, such as elevated temperatures (e.g., 30, 35, 40, 45, 50, 55, 60, 65, 70, 75, 80, 85, or 90° C., etc) that simulate actual operating and storage environments, for durations of up to 10, 11, 12, 13, 14, 15, 16, 20 weeks or longer. The results demonstrate markedly improved performance over the prior art and are illustrated in the examples provided in the later section. Moreover, gas formation is directly associated with increased internal resistance. Therefore, the reduced gas generation correlates with a lower or more controlled resistance increase—generally within an acceptable range of up to 30% over the testing period. Less gas also translates to minimized bulging of the battery housing or pouch, resulting in better regulation of internal pressure and maintaining acceptable levels of both volume change and pressure fluctuation of the battery.

### Reduced Gas Formation

When the lithium secondary battery using the non-aqueous electrolyte provided herein undergoes activation (formation) under the conditions described herein, the amount of gas formed in the electrolyte can be reduced by an amount at or about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, etc., compared to a lithium secondary battery using a non-aqueous electrolyte containing the compound represented by Chemical Formula 1, the cyclic carbonate and optionally the linear carbonate in amounts outside their respective amounts such as the volume ratios provided above, with all other factors being the same. In embodiments, the amount of gas formed in the electrolyte can be reduced by an amount within a range formed by any two numbers listed in the immediately preceding sentence, such as from about 10 to about 20, from about 20 to about 30, from bout 30 to about 40, from about 40 to about 50, from about 50 to about 60, from about 60 to about 70, from about 70 to about 80, from about 80 to about 90% etc., compared to a lithium secondary battery using a non-aqueous electrolyte containing the compound represented by Chemical Formula 1, the cyclic carbonate and optionally the linear carbonate in amounts outside their respective amounts provided herein, with all other factors being the same.

### Lithium Secondary Battery

### Components and Manufacturing of Lithium Secondary Battery

One aspect of the present disclosure provides a lithium secondary battery containing the aforementioned non-aqueous electrolyte. The lithium secondary battery provided herein includes an anode, a cathode facing the anode, a separator interposed between the anode and the cathode, and the aforementioned non-aqueous electrolyte. The lithium secondary battery can be manufactured by assembling an electrode assembly comprising the anode, the cathode facing the anode, and the separator interposed between the anode and the cathode into a battery case, and then injecting the aforementioned non-aqueous electrolyte. Since the description of the non-aqueous electrolyte has been provided above, the following describes the anode, cathode, and separator.

### Anode Active Material

The anode can include an anode active material. The anode active material can be a material capable of reversibly inserting/extracting lithium ions, and can include at least one selected from the group consisting of carbon-based active materials, (semi) metal-based active materials, and lithium metal. Specifically, it can include at least one selected from carbon-based active materials and (semi) metal-based active materials. In this specification, (semi) metal-based active materials can encompass both semimetal-based and metal-based active materials. In this case, the combined effect of ethylene carbonate and the compound represented by Chemical Formula 1 can be expressed at a significant level compared to using a lithium metal anode.

### Carbon-Based Material

The carbon-based active material can include at least one selected from the group consisting of artificial graphite, natural graphite, hard carbon, soft carbon, carbon black, graphene, and fibrous carbon, and preferably includes at least one selected from the group consisting of artificial graphite and natural graphite. The average particle diameter (D50) of the carbon-based active material can be 10 μm to 30 μm, preferably 15 μm to 25 μm, to ensure structural stability during charge/discharge and reduce side reactions with the electrolyte.

### (Semi)Metal-Based Material

The (semi) metal-based active material can include at least one selected from the group consisting of Cu, Ni, Na, K, Rb, Cs, Fr, Be, Mg, Ca, Sr, Si, Sb, Pb, In, Zn, Ba, Ra, Ge, Al, V, Ti, and Sn; at least one selected from the group consisting of Cu, Ni, Na, K, Rb, Cs, Fr, Be, Mg, Ca, Sr, Si, Sb, Pb, In, Zn, Ba, Ra, Ge, Al, V, Ti, and Sn and lithium alloys; at least one selected from the group consisting of Cu, Ni, Na, K, Rb, Cs, Fr, Be, Mg, Ca, Sr, Si, Sb, Pb, In, Zn, Ba, Ra, Ge, Al, V, Ti, and Sn oxides; lithium titanium oxide (LTO); lithium vanadium oxide; and others. More specifically, the (semi) metal-based active material can include silicon-based active materials.

### Silicon-Based Material

The silicon-based active material can include at least one selected from the group consisting of silicon (Si), silicon oxide (SiOx (0<x<2), preferably SiO), and silicon-carbon composites (Si/C Composite). The average particle diameter (D50) of the silicon-based active material can be 1 μm to 30 μm, preferably 2 μm to 15 μm, to ensure structural stability during charge/discharge and reduce side reactions with the electrolyte.

### Composite Anode Active Material

Specifically, the anode active material can include at least one selected from carbon-based active materials and silicon-based active materials, and specifically can include both carbon-based active materials and silicon-based active materials. When the anode active material includes both carbon-based active materials and silicon-based active materials, the weight ratio of the carbon-based active material to the silicon-based active material can be 50:50 to 99:1, specifically 70:30 to 99:1, more specifically 85:15 to 99:1, and even more specifically 90:10 to 99:1.

### Anode Current Collector

The anode can include an anode current collector and an anode active material layer disposed on at least one surface of the anode current collector. In this case, the anode active material can be included in the anode active material layer. The anode current collector is not particularly limited as long as it has high conductivity and does not cause chemical changes in the battery. Specifically, the anode current collector can be made of copper, stainless steel, aluminum, nickel, titanium, sintered carbon, or surface-treated copper or stainless steel with carbon, nickel, titanium, silver, etc., or aluminum-cadmium alloy. The anode current collector can typically have a thickness of 3 to 500 μm. The anode current collector can be surface-treated to form fine irregularities to enhance the bonding strength of the anode active material. For example, the anode current collector can be used in various forms such as film, sheet, foil, net, porous body, foam, nonwoven fabric, etc. The anode active material layer can be disposed on at least one surface of the anode current collector, specifically on one or both surfaces of the anode current collector.

### Anode Active Material Layer

The anode active material can be included in the anode active material layer in an amount of 60% to 99% by weight, preferably 75% to 95% by weight. The thickness of the anode active material layer can be 10 μm to 200 μm, preferably 20 μm to 150 μm.

Binder and/or Conductive Material

The anode active material layer can further include a binder and/or a conductive material along with the anode active material.

### Binder for Anode Active Material Layer

The binder is used to improve the adhesion between the anode active material layer and the anode current collector to enhance the performance of the battery. For example, it can include at least one selected from the group consisting of polyvinylidene fluoride-hexafluoropropylene copolymer (PVDF-co-HFP), polyvinylidene fluoride (PVDF), polyacrylonitrile, polymethyl methacrylate, polyvinyl alcohol, carboxymethyl cellulose (CMC), starch, hydroxypropyl cellulose, regenerated cellulose, polyvinylpyrrolidone, polytetrafluoroethylene, polyethylene, polypropylene, polyacrylic acid, ethylene-propylene-diene monomer (EPDM), sulfonated EPDM, styrene-butadiene rubber (SBR), fluorine rubber, and substances where their hydrogen is replaced with Li, Na, or Ca, and various copolymers thereof. The binder can be included in the anode active material layer in an amount of 0.5% to 10% by weight, preferably 1% to 5% by weight.

### Conductive Material for Anode Active Material Layer

The conductive material is not particularly limited as long as it has conductivity and does not cause chemical changes in the battery. For example, it can include graphite such as natural graphite or artificial graphite; carbon black such as carbon black, acetylene black, ketjen black, channel black, furnace black, lamp black, thermal black; conductive fibers such as carbon fibers or metal fibers; conductive tubes such as carbon nanotubes; fluorocarbon; metal powders such as aluminum or nickel powders; conductive whiskers such as zinc oxide or potassium titanate; conductive metal oxides such as titanium oxide; and conductive materials such as polyphenylene derivatives. The conductive material can be included in the anode active material layer in an amount of 0.5% to 10% by weight, preferably 1% to 5% by weight.

### Manufacturing of Anode

The anode can be manufactured by coating the anode slurry containing the anode active material, binder, conductive material, and/or solvent for forming the anode slurry on at least one surface of the anode current collector, followed by drying and rolling.

### Solvent for Anode Slurry

The solvent for forming the anode slurry can include at least one selected from the group consisting of distilled water, NMP (N-methyl-2-pyrrolidone), ethanol, methanol, and isopropyl alcohol, preferably including distilled water, to facilitate the dispersion of the anode active material, binder, and/or conductive material. The solid content of the anode slurry can be 30% to 80% by weight, specifically 40% to 70% by weight.

### Cathode

The cathode can face the anode.

### Cathode Active Material

The cathode can include a cathode active material. The cathode active material can be a compound capable of reversible intercalation and deintercalation, and is not particularly limited as long as it is a cathode active material used in the field. Specifically, the cathode active material can include lithium cobalt oxide (LiCoO2), lithium nickel oxide (LiNiO2), layered compounds substituted with one or more transition metals; lithium iron oxide (LiFe3O4); lithium iron phosphate (LiFePO4); lithium manganese oxides such as Li1+c1Mn2−c1O4 (0≤c1≤0.33), LiMnO3, LiMn2O3, LiMnO2; lithium copper oxide (Li2CuO2); vanadium oxides such as LiV3O8, V2O5, Cu2V2O7; nickel site-type lithium nickel oxides such as LiNi1−c2Mc2O2 (where M is selected from the group consisting of Co, Mn, Al, Cu, Fe, Mg, B, and Ga, and satisfies 0.01≤c2≤0.3); lithium manganese composite oxides such as LiMn2−c3Mc3O2 (where M is selected from the group consisting of Co, Ni, Fe, Cr, Zn, and Ta, and satisfies 0.01≤c3≤0.1) or Li2Mn3MO8 (where M is selected from the group consisting of Fe, Co, Ni, Cu, and Zn); and others, but is not limited to these. More specifically, the cathode active material can include at least one selected from the group consisting of lithium cobalt oxide (LiCoO2), high-nickel lithium nickel cobalt manganese oxide, lithium manganese-rich oxide, and lithium iron phosphate.

### High-Nickel Lithium Nickel Cobalt Manganese Oxide

The high-nickel lithium nickel cobalt manganese oxide can be represented by the following Chemical Formula A.

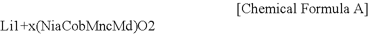

In Chemical Formula A, M is selected from the group consisting of W, Cu, Fe, V, Cr, Ti, Zr, Zn, Al, In, Ta, Y, La, Sr, Ga, Sc, Gd, Sm, Ca, Ce, Nb, Mg, B, and Mo, and 1+x, a, b, c, and d are the atomic fractions of the respective elements, satisfying 0≤x≤0.2, 0.50≤a<1, 0<b≤0.25, 0<c≤0.25, 0≤d≤0.1, and a+b+c+d=1. Preferably, a, b, c, and d satisfy 0.70≤a≤0.95, 0.025≤b≤0.20, 0.025≤c≤0.20, 0≤d≤0.05. Additionally, a, b, c, and d can satisfy 0.80≤a≤0.95, 0.025≤b≤0.15, 0.025≤c≤0.15, 0≤d≤0.05. Furthermore, a, b, c, and d can satisfy 0.85≤a≤0.90, 0.05≤b≤0.10, 0.05≤c≤0.10, 0≤d≤0.03.

### Lithium Manganese-Rich Oxide

The lithium manganese-rich oxide can include a compound represented by the following Chemical Formula B.

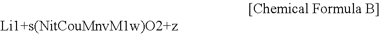

In Chemical Formula B, M1 is selected from the group consisting of W, Cu, Fe, V, Cr, Ti, Zr, Zn, Al, In, Ta, Y, La, Sr, Ga, Sc, Gd, Sm, Ca, Ce, Nb, Mg, B, and Mo, and s, t, u, v, w, and z are the atomic fractions of the respective elements, satisfying 0.05≤s≤1, 0≤t≤0.5, 0≤u≤0.3, 0.5≤v<1.0, 0≤w≤0.2, and 0≤z≤1. Preferably, s, t, u, v, w, and z satisfy 0.05≤s≤1.0, 0.1≤t≤0.5, 0≤u≤0.1, 0.5≤v<1.0, 0≤w≤0.2, and 0≤z≤1. More preferably, s, t, u, v, w, and z satisfy 0.10≤s≤0.50, 0.1≤t≤0.5, 0≤u≤0.1, 0.6≤v<1.0, 0≤w≤0.1, and 0≤z≤0.50.

### Lithium Iron Phosphate

The lithium iron phosphate can include a compound represented by the following Chemical Formula C.

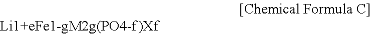

In Chemical Formula C, M2 is selected from the group consisting of Co, Ni, Mn, Al, Mg, Ti, and V, and X is F, S, or N, satisfying 0≤g≤0.5; −0.5≤e≤+0.5; and 0≤f≤0.1. Specifically, Chemical Formula C can be represented by LiFePO4 (g=0, e=0, and f=0).

### Cathode Current Collector

The cathode can include a cathode current collector and a cathode active material layer disposed on at least one surface of the cathode current collector. The cathode current collector is not particularly limited as long as it has high conductivity and does not cause chemical changes in the battery. Specifically, the cathode current collector can be made of copper, stainless steel, aluminum, nickel, titanium, sintered carbon, or aluminum-cadmium alloy. The cathode current collector can typically have a thickness of 3 to 500 μm. The cathode current collector can be surface-treated to form fine irregularities to enhance the bonding strength of the cathode active material. For example, the cathode current collector can be used in various forms such as film, sheet, foil, net, porous body, foam, nonwoven fabric, etc.

### Cathode Active Material Layer

The cathode active material layer can be disposed on at least one surface of the cathode current collector. Specifically, the cathode active material layer can be disposed on one or both surfaces of the cathode current collector. The cathode active material layer can include the aforementioned cathode active material. The cathode active material can be included in the cathode active material layer in an amount of 80% to 99% by weight, specifically 85% to 98% by weight. The cathode active material layer can further include a binder and/or a conductive material along with the aforementioned cathode active material. The thickness of the cathode active material layer can be 5 μm to 500 μm, preferably 20 μm to 200 μm.

### Binder for Cathode Active Material Layer

The binder is a component that assists in the bonding of the active material and conductive material to the current collector, and specifically can include at least one selected from the group consisting of polyvinylidene fluoride, polyvinyl alcohol, carboxymethyl cellulose (CMC), starch, hydroxypropyl cellulose, regenerated cellulose, polyvinylpyrrolidone, polytetrafluoroethylene, polyethylene, polypropylene, ethylene-propylene-diene terpolymer (EPDM), sulfonated EPDM, styrene-butadiene rubber, and fluorine rubber, preferably including polyvinylidene fluoride. The binder can be included in the cathode active material layer in an amount of 1% to 20% by weight, preferably 1.2% to 10% by weight, to sufficiently secure the bonding strength between the components of the cathode active material layer.

### Conductive Material for Cathode Active Material Layer

The conductive material can be used to assist and enhance the conductivity of the secondary battery, and is not particularly limited as long as it has conductivity and does not cause chemical changes. Specifically, the cathode conductive material can include graphite such as natural graphite or artificial graphite; carbon black such as carbon black, acetylene black, ketjen black, channel black, furnace black, lamp black, thermal black; conductive fibers such as carbon fibers or metal fibers; conductive tubes such as carbon nanotubes; fluorocarbon; metal powders such as aluminum or nickel powders; conductive whiskers such as zinc oxide or potassium titanate; conductive metal oxides such as titanium oxide; and conductive materials such as polyphenylene derivatives, preferably including carbon nanotubes for enhanced conductivity. The conductive material can be included in the cathode active material layer in an amount of 1% to 20% by weight, preferably 1.2% to 10% by weight, to sufficiently secure electrical conductivity.

### Manufacturing of Cathode

The cathode can be manufactured by coating the cathode slurry containing the cathode active material, binder, conductive material, and solvent for forming the cathode slurry on the cathode current collector, followed by drying and rolling.

### Separator

The separator can be interposed between the cathode and the anode. The separator can be a conventional porous polymer film used as a separator, such as a porous polymer film made of polyolefin-based polymers like ethylene homopolymer, propylene homopolymer, ethylene/butene copolymer, ethylene/hexene copolymer, and ethylene/methacrylate copolymer, used alone or laminated, or conventional porous nonwoven fabric, such as nonwoven fabric made of high melting point glass fibers or polyethylene terephthalate fibers, but is not limited to these. Additionally, a coated separator containing ceramic components or polymer substances can be used to secure heat resistance or mechanical strength, and can be used in single-layer or multi-layer structures.

### Shape of Lithium Secondary Battery

The shape of the lithium secondary battery of the present invention is not particularly limited, but can be cylindrical, prismatic, pouch-shaped, or coin-shaped using a can.

### EXAMPLES

Hereinafter, the present disclosure will be illustrated in more detail through specific examples. However, these examples are merely illustrative to aid understanding of the present invention and do not limit the scope of the present invention. Various modifications and changes within the scope and spirit of the present invention are apparent to those skilled in the art, and such modifications and changes naturally fall within the scope of the appended claims.

Unless otherwise specified, the volume of each component of the organic solvent described herein is determined individually at 25° C.

Further, Examples 1-6, 16-21, and 38-39 respectively correspond to Examples 1-6, Comparative Examples 1-6, and Experimental Examples 1-2 in PCT Application No. PCT/KR2025/003679, which is incorporated herein in its entirety by reference. In the event of any discrepancies between the Examples 1-6, 16-21, and 38-39 herein and the examples in PCT Application No. PCT/KR2025/003679, the examples in PCT Application No. PCT/KR2025/003679 shall be deemed the authoritative version.

### Example 1

### Preparation of Non-Aqueous Electrolyte for Lithium Secondary Battery

Ethylene carbonate (EC), ethyl methyl carbonate (EMC), and the compound represented by Chemical Formula 1-A were mixed in a volume ratio of 30:50:20 in an organic solvent, and LiPF6 was dissolved to a concentration of 1.0M, followed by the addition of vinylene carbonate (VC) to a concentration of 0.8% by weight to prepare a non-aqueous electrolyte for lithium secondary battery (see Table 1 below).

### Manufacture of Secondary Battery

The cathode slurry (solid content 60% by weight) was prepared by adding the cathode active material (Li(Ni0.9Mn0.03Co0.06Al0.01)O2), conductive material (carbon black), and binder (polyvinylidene fluoride) to the solvent N-methyl-2-pyrrolidone (NMP) in a weight ratio of 97.6:0.8:1.6. The cathode slurry was coated and dried on an aluminum thin film (Al foil) with a thickness of 13.5 μm, followed by roll pressing to manufacture the cathode.

An anode slurry (solid content: 60 wt %) was prepared by adding an anode active material (graphite:SiO=94:6 weight ratio), a binder (SBR-CMC), and a conductive material (carbon black) to water as a solvent in a weight ratio of 97.7:0.8:1.5. The anode slurry was coated onto a copper (Cu) thin film with a thickness of 6 μm, which serves as the anode current collector, and then dried and roll-pressed to fabricate the anode.

A porous polypropylene separator was interposed between the prepared cathode and anode to fabricate an electrode assembly. This assembly was housed in a battery case, and the previously prepared non-aqueous electrolyte for a lithium secondary battery was injected to complete the lithium secondary battery.

### Example 2

### Preparation of Non-Aqueous Electrolyte for Lithium Secondary Battery

A non-aqueous electrolyte was prepared by dissolving LiPF6 to a concentration of 1.0 M in an organic solvent mixture of ethylene carbonate (EC), ethyl methyl carbonate (EMC), and a compound represented by Chemical Formula 1-A in a volume ratio of 30:30:40. Vinylene carbonate (VC) was then added to a content of 0.8 wt % (see Table 1 below).

### Fabrication of Lithium Secondary Battery

Except for using the above-prepared non-aqueous electrolyte, the lithium secondary battery was fabricated in the same manner as in Example 1.

### Example 3

### Preparation of Non-Aqueous Electrolyte for Lithium Secondary Battery

A non-aqueous electrolyte was prepared by dissolving LiPF6 to a concentration of 1.0 M in an organic solvent mixture of ethylene carbonate (EC), ethyl methyl carbonate (EMC), and a compound represented by Chemical Formula 1-A in a volume ratio of 30:55:15. Vinylene carbonate (VC) was then added to a content of 0.8 wt % (see Table 1 below).

### Fabrication of Lithium Secondary Battery

Except for using the above-prepared non-aqueous electrolyte, the lithium secondary battery was fabricated in the same manner as in Example 1.

### Example 4

### Preparation of Non-Aqueous Electrolyte for Lithium Secondary Battery

A non-aqueous electrolyte was prepared by dissolving LiPF6 to a concentration of 1.0 M in an organic solvent mixture of ethylene carbonate (EC), ethyl methyl carbonate (EMC), and a compound represented by Chemical Formula 1-A in a volume ratio of 20:40:40. Vinylene carbonate (VC) was then added to a content of 0.8 wt % (see Table 1 below).

### Fabrication of Lithium Secondary Battery

Except for using the above-prepared non-aqueous electrolyte, the lithium secondary battery was fabricated in the same manner as in Example 1.

### Example 5

### Preparation of Non-Aqueous Electrolyte for Lithium Secondary Battery

A non-aqueous electrolyte was prepared by dissolving LiPF6 to a concentration of 1.0 M in an organic solvent mixture of ethylene carbonate (EC), ethyl methyl carbonate (EMC), and a compound represented by Chemical Formula 1-A in a volume ratio of 20:75:5. Vinylene carbonate (VC) was then added to a content of 0.8 wt % (see Table 1 below).

Ethylene carbonate (EC), ethyl methyl carbonate (EMC), and the compound represented by Chemical Formula 1-A were mixed in a volume ratio of 20:75:5 in an organic solvent, and LiPF6 was dissolved to a concentration of 1.0M, followed by the addition of vinylene carbonate (VC) to a concentration of 0.8% by weight to prepare a non-aqueous electrolyte for lithium secondary battery (see Table 1 below).

### Manufacture of Secondary Battery

Except for using the non-aqueous electrolyte for lithium secondary battery prepared above, the lithium secondary battery was manufactured in the same manner as in Example 1.

### Example 6

### Preparation of Non-Aqueous Electrolyte for Lithium Secondary Battery

Ethylene carbonate (EC), ethyl methyl carbonate (EMC), and the compound represented by Chemical Formula 1-A were mixed in a volume ratio of 30:60:10 in an organic solvent, and LiPF6 was dissolved to a concentration of 1.0M, followed by the addition of vinylene carbonate (VC) to a concentration of 0.8% by weight to prepare a non-aqueous electrolyte for lithium secondary battery (see Table 1 below).

### Manufacture of Secondary Battery

Except for using the non-aqueous electrolyte for lithium secondary battery prepared above, the lithium secondary battery was manufactured in the same manner as in Example 1.

### Example 7

### Preparation of Non-Aqueous Electrolytes for Lithium Secondary Batteries

Non-aqueous electrolytes for lithium secondary batteries each are prepared by mixing a lithium salt and an organic solvent consisting of ethylene carbonate (EC) and the compound represented by Chemical Formula 1-A. The organic solvents include the compound represented by Chemical Formula 1-A in the amounts listed in the paragraph with the heading “Amount of Sulfonamide Compound,” respectively. The amount of the ethylene carbonate (EC) in each organic solvent is the remaining amount of the corresponding organic solvent.

### Manufacture of Secondary Batteries

Lithium secondary batteries are manufactured in the same manner as in Example 1, except that the non-aqueous electrolytes prepared above are used in respective batteries.

### Examples 8

### Preparation of Non-Aqueous Electrolytes for Lithium Secondary Batteries

Non-aqueous electrolytes for lithium secondary batteries are prepared in the same manner as in Example 7, except that the compound represented by Chemical Formula 1-A is replaced by each of the compounds represented by Chemical Formulas 1-B, 1-C, 1-D, 1-E, 1-F, 1-G, 1-H, 1-I, 1-J, 1-K, 1-L, 1-M, 1-N, 1-O, 1-P, and 1-Q in the organic solvents, respectively. The prepared non-aqueous electrolytes thus include each of the compounds represented by Chemical Formulas 1-B, 1-C, 1-D, 1-E, 1-F, 1-G, 1-H, 1-I, 1-J, 1-K, 1-L, 1-M, 1-N, 1-O, 1-P, and 1-Q in each of the amounts listed in the paragraph with the heading “Amount of Sulfonamide Compound,” respectively. This means there are non-aqueous electrolytes including the compound represented by Chemical Formulas 1-B in each of the amounts listed in the paragraph with the heading “Amount of Sulfonamide Compound”; non-aqueous electrolytes including the compound represented by Chemical Formulas 1-C in each of the amounts listed in the paragraph with the heading “Amount of Sulfonamide Compound”; and non-aqueous electrolytes including the compound represented by Chemical Formulas 1-D in each of the amounts listed in the paragraph with the heading “Amount of Sulfonamide Compound”, etc.

### Manufacture of Secondary Batteries

Lithium secondary batteries are manufactured in the same manner as in Example 1, except that the non-aqueous electrolytes prepared above are used in the respective batteries.

### Example 9

### Preparation of Non-Aqueous Electrolytes for Lithium Secondary Batteries

Non-aqueous electrolytes for lithium secondary batteries are prepared in the same manner as in Examples 7-8, except that ethylene carbonate (EC) is replaced with each of propylene carbonate (PC), vinylene carbonate (VC), methyl ethylene carbonate (MEC), 1,2-butylene carbonate, 2,3-butylene carbonate, 1,2-pentylene carbonate, 2,3-pentylene carbonate, or methyl vinylene carbonate, ethyl vinylene carbonate, 1,2-dimethyl vinylene carbonate, 1,2-diethyl vinylene carbonate, 1-ethyl-2-vinylethylene carbonate, 1-n-propyl-2-vinylethylene carbonate, 1-methyl-2-vinyl ethylene carbonate, 1,1-divinyl ethylene carbonate, 1,2-divinyl ethylene carbonate, 1,1-dimethyl-2-ethylene carbonate, 1,1-diethyl-2-methylene-ethylene carbonate in the organic solvents, respectively.

### Manufacture of Secondary Batteries

Lithium secondary batteries are manufactured in the same manner as in Example 1, except that the non-aqueous electrolytes prepared above are used in the respective batteries.

### Example 10

### Preparation of Non-Aqueous Electrolytes for Lithium Secondary Batteries

Non-aqueous electrolytes for lithium secondary batteries are prepared in the same manner as in Examples 7-8, except that ethylene carbonate (EC) is replaced with each of fluoroethylene carbonate, 1,2-difluoroethylene carbonate, 1,1-difluoroethylene carbonate, 1,1,2-trifluoroethylene carbonate, tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, and trifluoromethylethylene, fluoro vinylene carbonate, trifluoromethyl carbonate in the organic solvents, respectively.

### Manufacture of Secondary Batteries

Lithium secondary batteries are manufactured in the same manner as in Example 1, except that the non-aqueous electrolytes prepared above are used in the respective batteries.

### Example 11

### Preparation of Non-Aqueous Electrolytes for Lithium Secondary Batteries

Non-aqueous electrolytes for lithium secondary batteries each are prepared by mixing a lithium salt and an organic solvent consisting of ethylene carbonate (EC), the compound represented by Chemical Formula 1-A, and dimethyl carbonate (DMC). The organic solvents include the compound represented by Chemical Formula 1-A in the amounts listed in the paragraph with the heading “Amount of Sulfonamide Compound,” respectively; and the ethylene carbonate (EC) in an amount of 1 vol % of the total volume of the organic solvent. The amount of the dimethyl carbonate (DMC) in each organic solvent is the remaining amount of the corresponding organic solvent.

### Manufacture of Secondary Batteries

Lithium secondary batteries are manufactured in the same manner as in Example 1, except that the non-aqueous electrolytes prepared above are used in respective batteries.

### Example 12

### Preparation of Non-Aqueous Electrolytes for Lithium Secondary Batteries

Non-aqueous electrolytes for lithium secondary batteries each are prepared in the same manner as in Example 11, except that the organic solvents include various amounts of the ethylene carbonate (EC), respectively, such that the respective volume ratios of the compound represented by Chemical Formula 1-A to the ethylene carbonate (EC) in these organic solvents are the ratios listed in the paragraph with the heading “Volume Ratio of Sulfonamide Compound to Cyclic Carbonate,” respectively. The amount of the dimethyl carbonate (DMC) in each organic solvent is the remaining amount of the corresponding organic solvent.

### Manufacture of Secondary Batteries

Lithium secondary batteries are manufactured in the same manner as in Example 1, except that the non-aqueous electrolytes prepared above are used in respective batteries.

### Example 13

### Preparation of Non-Aqueous Electrolytes for Lithium Secondary Batteries

Non-aqueous electrolytes for lithium secondary batteries each are prepared in the same manner as in Examples 11-12, except that the ethylene carbonate (EC) is replaced with each of propylene carbonate (PC), vinylene carbonate (VC), methyl ethylene carbonate (MEC), 1,2-butylene carbonate, 2,3-butylene carbonate, 1,2-pentylene carbonate, 2,3-pentylene carbonate, or methyl vinylene carbonate, ethyl vinylene carbonate, 1,2-dimethyl vinylene carbonate, 1,2-diethyl vinylene carbonate, 1-ethyl-2-vinylethylene carbonate, 1-n-propyl-2-vinylethylene carbonate, 1-methyl-2-vinyl ethylene carbonate, 1,1-divinyl ethylene carbonate, 1,2-divinyl ethylene carbonate, 1,1-dimethyl-2-ethylene carbonate, 1,1-diethyl-2-methylene-ethylene carbonate in the organic solvents, respectively.

### Manufacture of Secondary Batteries

Lithium secondary batteries are manufactured in the same manner as in Example 1, except that the non-aqueous electrolytes prepared above are used in respective batteries.

### Example 14

### Preparation of Non-Aqueous Electrolytes for Lithium Secondary Batteries

Non-aqueous electrolytes for lithium secondary batteries each are prepared in the same manner as in Examples 11-12, except that the ethylene carbonate (EC) is replaced with each of fluoroethylene carbonate, 1,2-difluoroethylene carbonate, 1,1-difluoroethylene carbonate, 1,1,2-trifluoroethylene carbonate, tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, and trifluoromethylethylene, fluoro vinylene carbonate, trifluoromethyl carbonate in the organic solvents, respectively.

### Manufacture of Secondary Batteries

Lithium secondary batteries are manufactured in the same manner as in Example 1, except that the non-aqueous electrolytes prepared above are used in respective batteries.

### Example 15

### Preparation of Non-Aqueous Electrolytes for Lithium Secondary Batteries

Non-aqueous electrolytes for lithium secondary batteries each are prepared in the same manner as in Examples 11-14, except that the dimethyl carbonate (DMC) is replaced with each of diethyl carbonate (DEC), dipropyl carbonate (DPC), ethyl methyl carbonate (EMC), methyl propyl carbonate (MPC), and ethyl propyl carbonate (EPC) in the organic solvents, respectively.

### Manufacture of Secondary Batteries

Lithium secondary batteries are manufactured in the same manner as in Example 1, except that the non-aqueous electrolytes prepared above are used in respective batteries.

### Example 16

### Preparation of Non-Aqueous Electrolytes for Lithium Secondary Batteries

Non-aqueous electrolytes for lithium secondary batteries each are prepared by mixing a lithium salt and an organic solvent consisting of ethylene carbonate (EC), the compound represented by Chemical Formula 1-A, dimethyl carbonate (DMC), and methyl acetate. The organic solvents include the compound represented by Chemical Formula 1-A in the amounts listed in the paragraph with the heading “Amount of Sulfonamide Compound,” respectively. The ethylene carbonate (EC) is in an amount of 1 vol % of the total volume of the organic solvent. The dimethyl carbonate (DMC) is in an amount of 1 vol % of the total volume of the organic solvent. The amount of the methyl acetate in each organic solvent is the remaining amount of the corresponding organic solvent.

### Manufacture of Secondary Batteries

Lithium secondary batteries are manufactured in the same manner as in Example 1, except that the non-aqueous electrolytes prepared above are used in respective batteries.

### Example 17

### Preparation of Non-Aqueous Electrolytes for Lithium Secondary Batteries

Non-aqueous electrolytes for lithium secondary batteries each are prepared in the same manner as in Example 16, except that the organic solvents include various amounts of the ethylene carbonate (EC) and various amounts of dimethyl carbonate (DMC), respectively, such that the respective volume ratios of the compound represented by Chemical Formula 1-A to the ethylene carbonate (EC) in these organic solvents are the ratios listed in the paragraph with the heading “Volume Ratio of Sulfonamide Compound to Cyclic Carbonate,” respectively; and the respective volume ratios of the compound represented by Chemical Formula 1-A to the dimethyl carbonate (DMC) in these organic solvents are the ratios listed in the paragraph with the heading “Volume Ratio of Sulfonamide Compound to Linear Carbonate,” respectively. The amount of the methyl acetate in each organic solvent is the remaining amount of the corresponding organic solvent.

### Manufacture of Secondary Batteries

Lithium secondary batteries are manufactured in the same manner as in Example 1, except that the non-aqueous electrolytes prepared above are used in respective batteries.

### Example 18

### Preparation of Non-Aqueous Electrolytes for Lithium Secondary Batteries

Non-aqueous electrolytes for lithium secondary batteries each are prepared in the same manner as in Examples 16-17, except that the ethylene carbonate (EC) is replaced with each of propylene carbonate (PC), vinylene carbonate (VC), methyl ethylene carbonate (MEC), 1,2-butylene carbonate, 2,3-butylene carbonate, 1,2-pentylene carbonate, 2,3-pentylene carbonate, or methyl vinylene carbonate, ethyl vinylene carbonate, 1,2-dimethyl vinylene carbonate, 1,2-diethyl vinylene carbonate, 1-ethyl-2-vinylethylene carbonate, 1-n-propyl-2-vinylethylene carbonate, 1-methyl-2-vinyl ethylene carbonate, 1,1-divinyl ethylene carbonate, 1,2-divinyl ethylene carbonate, 1,1-dimethyl-2-ethylene carbonate, 1,1-diethyl-2-methylene-ethylene carbonate in the organic solvents, respectively.

### Manufacture of Secondary Batteries

Lithium secondary batteries are manufactured in the same manner as in Example 1, except that the non-aqueous electrolytes prepared above are used in respective batteries.

### Example 19

### Preparation of Non-Aqueous Electrolytes for Lithium Secondary Batteries

Non-aqueous electrolytes for lithium secondary batteries each are prepared in the same manner as in Examples 16-17, except that the ethylene carbonate (EC) is replaced with each of fluoroethylene carbonate, 1,2-difluoroethylene carbonate, 1,1-difluoroethylene carbonate, 1,1,2-trifluoroethylene carbonate, tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, and trifluoromethylethylene, fluoro vinylene carbonate, trifluoromethyl carbonate in the organic solvents, respectively.

### Manufacture of Secondary Batteries

Lithium secondary batteries are manufactured in the same manner as in Example 1, except that the non-aqueous electrolytes prepared above are used in respective batteries.

### Example 20

### Preparation of Non-Aqueous Electrolytes for Lithium Secondary Batteries

Non-aqueous electrolytes for lithium secondary batteries each are prepared in the same manner as in Examples 16-19, except that the dimethyl carbonate (DMC) is replaced with each of diethyl carbonate (DEC), dipropyl carbonate (DPC), ethyl methyl carbonate (EMC), methyl propyl carbonate (MPC), and ethyl propyl carbonate (EPC) in the organic solvents, respectively.

### Manufacture of Secondary Batteries

Lithium secondary batteries are manufactured in the same manner as in Example 1, except that the non-aqueous electrolytes prepared above are used in respective batteries.

### Example 21

### Preparation of Non-Aqueous Electrolytes for Lithium Secondary Batteries

Non-aqueous electrolytes for lithium secondary batteries each are prepared in the same manner as in Examples 16-20, except that the methyl acetate is replaced with each of ethyl acetate, propyl acetate, methyl propionate, ethyl propionate, propyl propionate, butyl propionate, γ-butyrolactone, γ-valerolactone, γ-caprolactone, σ-valerolactone, ε-caprolactone, dimethyl ether, diethyl ether, dipropyl ether, methyl ethyl ether, methyl propyl ether, ethyl propyl ether, 1,3-dioxolane (DOL), 2,2-bis(trifluoromethyl)-1,3-dioxolane (TFDOL), dimethoxyethane (glyme, DME), diethoxyethane, diglyme, triglyme, tetraglyme (TEGDME), acetonitrile, propionitrile, butyronitrile, valeronitrile, caprylonitrile, heptanonitrile, cyclopentane carbonitrile, cyclohexane carbonitrile, 2-fluorobenzonitrile, 4-fluorobenzonitrile, difluorobenzonitrile, trifluorobenzonitrile, phenylacetonitrile, 2-fluorophenylacetonitrile, and 4-fluorophenylacetonitrile in the organic solvents, respectively.

### Manufacture of Secondary Batteries

Lithium secondary batteries are manufactured in the same manner as in Example 1, except that the non-aqueous electrolytes prepared above are used in respective batteries.

### Example 22

### Preparation of Non-Aqueous Electrolyte for Lithium Secondary Battery

Ethylene carbonate (EC) and ethyl methyl carbonate (EMC) were mixed in a volume ratio of 30:70 in an organic solvent, and LiPF6 was dissolved to a concentration of 1.0M, followed by the addition of vinylene carbonate (VC) to a concentration of 0.8% by weight to prepare a non-aqueous electrolyte for lithium secondary battery (see Table 1 below).

### Manufacture of Secondary Battery

Except for using the non-aqueous electrolyte for lithium secondary battery prepared above, the lithium secondary battery was manufactured in the same manner as in Example 1.

### Example 23

### Preparation of Non-Aqueous Electrolyte for Lithium Secondary Battery

Ethylene carbonate (EC), ethyl methyl carbonate (EMC), and the compound represented by Chemical Formula 1-A were mixed in a volume ratio of 10:50:40 in an organic solvent, and LiPF6 was dissolved to a concentration of 1.0M, followed by the addition of vinylene carbonate (VC) to a concentration of 0.8% by weight to prepare a non-aqueous electrolyte for lithium secondary battery (see Table 1 below).

### Manufacture of Secondary Battery

Except for using the non-aqueous electrolyte for lithium secondary battery prepared above, the lithium secondary battery was manufactured in the same manner as in Example 1.

### Example 24

### Preparation of Non-Aqueous Electrolyte for Lithium Secondary Battery

Ethylene carbonate (EC), ethyl methyl carbonate (EMC), and the compound represented by Chemical Formula 1-A were mixed in a volume ratio of 30:65:5 in an organic solvent, and LiPF6 was dissolved to a concentration of 1.0M, followed by the addition of vinylene carbonate (VC) to a concentration of 0.8% by weight to prepare a non-aqueous electrolyte for lithium secondary battery (see Table 1 below).

### Manufacture of Secondary Battery

Except for using the non-aqueous electrolyte for lithium secondary battery prepared above, the lithium secondary battery was manufactured in the same manner as in Example 1.

### Example 25

### Preparation of Non-Aqueous Electrolyte for Lithium Secondary Battery

Ethylene carbonate (EC), ethyl methyl carbonate (EMC), and the compound represented by Chemical Formula R-1 were mixed in a volume ratio of 30:50:20 in an organic solvent, and LiPF6 was dissolved to a concentration of 1.0M, followed by the addition of vinylene carbonate (VC) to a concentration of 0.8% by weight to prepare a non-aqueous electrolyte for lithium secondary battery (see Table 1 below).

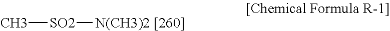

### Manufacture of Secondary Battery

Except for using the non-aqueous electrolyte for lithium secondary battery prepared above, the lithium secondary battery was manufactured in the same manner as in Example 1.

### Example 26

### Preparation of Non-Aqueous Electrolyte for Lithium Secondary Battery

Ethylene carbonate (EC), ethyl methyl carbonate (EMC), and the compound represented by Chemical Formula R-2 were mixed in a volume ratio of 30:50:20 in an organic solvent, and LiPF6 was dissolved to a concentration of 1.0M, followed by the addition of vinylene carbonate (VC) to a concentration of 0.8% by weight to prepare a non-aqueous electrolyte for lithium secondary battery (see Table 1 below).

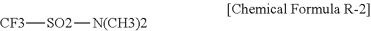

### Manufacture of Secondary Battery

Except for using the non-aqueous electrolyte for lithium secondary battery prepared above, the lithium secondary battery was manufactured in the same manner as in Example 1.

### Example 27

### Preparation of Non-Aqueous Electrolyte for Lithium Secondary Battery

Fluoroethylene carbonate (FEC), ethyl methyl carbonate (EMC), and the compound represented by Chemical Formula 1-A were mixed in a volume ratio of 30:50:20 in an organic solvent, and LiPF6 was dissolved to a concentration of 1.0M, followed by the addition of vinylene carbonate (VC) to a concentration of 0.8% by weight to prepare a non-aqueous electrolyte for lithium secondary battery (see Table 1 below).

### Manufacture of Secondary Battery

Except for using the non-aqueous electrolyte for lithium secondary battery prepared above, the lithium secondary battery was manufactured in the same manner as in Example 1.

### Example 28

### Preparation of Non-Aqueous Electrolyte for Lithium Secondary Battery

A non-aqueous electrolyte for lithium secondary battery is prepared by mixing a lithium salt and an organic solvent consisting of ethylene carbonate (EC).

### Manufacture of Secondary Battery

A lithium secondary battery is manufactured in the same manner as in Example 1, except that the non-aqueous electrolyte prepared above is used in the battery.

### Example 29

### Preparation of Non-Aqueous Electrolytes for Lithium Secondary Batteries

Non-aqueous electrolytes for lithium secondary batteries are prepared in the same manner as in Example 22, except that the ethylene carbonate (EC) is replaced with each of propylene carbonate (PC), vinylene carbonate (VC), methyl ethylene carbonate (MEC), 1,2-butylene carbonate, 2,3-butylene carbonate, 1,2-pentylene carbonate, 2,3-pentylene carbonate, or methyl vinylene carbonate, ethyl vinylene carbonate, 1,2-dimethyl vinylene carbonate, 1,2-diethyl vinylene carbonate, 1-ethyl-2-vinylethylene carbonate, 1-n-propyl-2-vinylethylene carbonate, 1-methyl-2-vinyl ethylene carbonate, 1,1-divinyl ethylene carbonate, 1,2-divinyl ethylene carbonate, 1,1-dimethyl-2-ethylene carbonate, 1,1-diethyl-2-methylene-ethylene carbonate, respectively.

### Manufacture of Secondary Batteries

Lithium secondary batteries are manufactured in the same manner as in Example 1, except that the non-aqueous electrolytes prepared above are used in the respective batteries.

### Example 30

### Preparation of Non-Aqueous Electrolytes for Lithium Secondary Batteries

Non-aqueous electrolytes for lithium secondary batteries are prepared in the same manner as in Example 22, except that the ethylene carbonate (EC) is replaced with each of fluoroethylene carbonate, 1,2-difluoroethylene carbonate, 1,1-difluoroethylene carbonate, 1,1,2-trifluoroethylene carbonate, tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, and trifluoromethylethylene, fluoro vinylene carbonate, trifluoromethyl carbonate, respectively.

### Manufacture of Secondary Batteries

Lithium secondary batteries are manufactured in the same manner as in Example 1, except that the non-aqueous electrolytes prepared above are used in the respective batteries.

### Example 31

### Preparation of Non-Aqueous Electrolytes for Lithium Secondary Batteries

Non-aqueous electrolytes for lithium secondary batteries each are prepared by mixing a lithium salt and an organic solvent consisting of ethylene carbonate (EC) and dimethyl carbonate (DMC). The organic solvents include the ethylene carbonate (EC) in the same amounts as in Examples 11-12, respectively. The respective amount of the dimethyl carbonate (DMC) in the organic solvents are the respective remaining amounts of the organic solvents.

### Manufacture of Secondary Batteries

Lithium secondary batteries are manufactured in the same manner as in Example 1, except that the non-aqueous electrolytes prepared above are used in the respective batteries.

### Example 32

### Preparation of Non-Aqueous Electrolytes for Lithium Secondary Batteries

Non-aqueous electrolytes for lithium secondary batteries each are prepared in the same manner as in Example 31, except that the ethylene carbonate (EC) is replaced with each of propylene carbonate (PC), vinylene carbonate (VC), methyl ethylene carbonate (MEC), 1,2-butylene carbonate, 2,3-butylene carbonate, 1,2-pentylene carbonate, 2,3-pentylene carbonate, or methyl vinylene carbonate, ethyl vinylene carbonate, 1,2-dimethyl vinylene carbonate, 1,2-diethyl vinylene carbonate, 1-ethyl-2-vinylethylene carbonate, 1-n-propyl-2-vinylethylene carbonate, 1-methyl-2-vinyl ethylene carbonate, 1,1-divinyl ethylene carbonate, 1,2-divinyl ethylene carbonate, 1,1-dimethyl-2-ethylene carbonate, 1,1-diethyl-2-methylene-ethylene carbonate, fluoroethylene carbonate, 1,2-difluoroethylene carbonate, 1,1-difluoroethylene carbonate, 1,1,2-trifluoroethylene carbonate, tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, trifluoromethylethylene, fluoro vinylene carbonate, and trifluoromethyl carbonate.

### Manufacture of Secondary Batteries

Lithium secondary batteries are manufactured in the same manner as in Example 1, except that the non-aqueous electrolytes prepared above are used in the respective batteries.

### Example 33

### Preparation of Non-Aqueous Electrolytes for Lithium Secondary Batteries

Non-aqueous electrolytes for lithium secondary batteries each are prepared in the same manner as in Examples 31-32, except that the dimethyl carbonate (DMC) is replaced with each of diethyl carbonate (DEC), dipropyl carbonate (DPC), ethyl methyl carbonate (EMC), methyl propyl carbonate (MPC), and ethyl propyl carbonate (EPC) in the organic solvents, respectively.

### Manufacture of Secondary Batteries

Lithium secondary batteries are manufactured in the same manner as in Example 1, except that the non-aqueous electrolytes prepared above are used in the respective batteries.

### Example 34

### Preparation of Non-Aqueous Electrolytes for Lithium Secondary Batteries

Non-aqueous electrolytes for lithium secondary batteries each are prepared by mixing a lithium salt and an organic solvent consisting of ethylene carbonate (EC), dimethyl carbonate (DMC), and methyl acetate. The organic solvents include the ethylene carbonate (EC) and the dimethyl carbonate (DMC) in the same amounts as in Examples 16-17, respectively. The respective amount of the methyl acetate in the organic solvents are the respective remaining amounts of the organic solvents.

### Manufacture of Secondary Batteries

Lithium secondary batteries are manufactured in the same manner as in Example 1, except that the non-aqueous electrolytes prepared above are used in the respective batteries.

### Example 35

### Preparation of Non-Aqueous Electrolytes for Lithium Secondary Batteries

Non-aqueous electrolytes for lithium secondary batteries each are prepared in the same manner as in Example 34, except that the ethylene carbonate (EC) is replaced with each of propylene carbonate (PC), vinylene carbonate (VC), methyl ethylene carbonate (MEC), 1,2-butylene carbonate, 2,3-butylene carbonate, 1,2-pentylene carbonate, 2,3-pentylene carbonate, or methyl vinylene carbonate, ethyl vinylene carbonate, 1,2-dimethyl vinylene carbonate, 1,2-diethyl vinylene carbonate, 1-ethyl-2-vinylethylene carbonate, 1-n-propyl-2-vinylethylene carbonate, 1-methyl-2-vinyl ethylene carbonate, 1,1-divinyl ethylene carbonate, 1,2-divinyl ethylene carbonate, 1,1-dimethyl-2-ethylene carbonate, 1,1-diethyl-2-methylene-ethylene carbonate, fluoroethylene carbonate, 1,2-difluoroethylene carbonate, 1,1-difluoroethylene carbonate, 1,1,2-trifluoroethylene carbonate, tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, trifluoromethylethylene, fluoro vinylene carbonate, and trifluoromethyl carbonate.

### Manufacture of Secondary Batteries

Lithium secondary batteries are manufactured in the same manner as in Example 1, except that the non-aqueous electrolytes prepared above are used in the respective batteries.

### Example 36

### Preparation of Non-Aqueous Electrolytes for Lithium Secondary Batteries

Non-aqueous electrolytes for lithium secondary batteries each are prepared in the same manner as in Examples 34-35, except that the dimethyl carbonate (DMC) is replaced with each of diethyl carbonate (DEC), dipropyl carbonate (DPC), ethyl methyl carbonate (EMC), methyl propyl carbonate (MPC), and ethyl propyl carbonate (EPC) in the organic solvents, respectively.

### Manufacture of Secondary Batteries

Lithium secondary batteries are manufactured in the same manner as in Example 1, except that the non-aqueous electrolytes prepared above are used in the respective batteries.

### Example 37

### Preparation of Non-Aqueous Electrolytes for Lithium Secondary Batteries

Non-aqueous electrolytes for lithium secondary batteries each are prepared in the same manner as in Examples 34-36, except that the methyl acetate is replaced with each of ethyl acetate, propyl acetate, methyl propionate, ethyl propionate, propyl propionate, butyl propionate, γ-butyrolactone, γ-valerolactone, γ-caprolactone, σ-valerolactone, ε-caprolactone, dimethyl ether, diethyl ether, dipropyl ether, methyl ethyl ether, methyl propyl ether, ethyl propyl ether, 1,3-dioxolane (DOL), 2,2-bis(trifluoromethyl)-1,3-dioxolane (TFDOL), dimethoxyethane (glyme, DME), diethoxyethane, diglyme, triglyme, tetraglyme (TEGDME), acetonitrile, propionitrile, butyronitrile, valeronitrile, caprylonitrile, heptanonitrile, cyclopentane carbonitrile, cyclohexane carbonitrile, 2-fluorobenzonitrile, 4-fluorobenzonitrile, difluorobenzonitrile, trifluorobenzonitrile, phenylacetonitrile, 2-fluorophenylacetonitrile, and 4-fluorophenylacetonitrile in the organic solvents, respectively.

### Manufacture of Secondary Batteries

Lithium secondary batteries are manufactured in the same manner as in Example 1, except that the non-aqueous electrolytes prepared above are used in respective batteries.

TABLE 1

| | Volume Percentage of Each Component in the Organic Solvent (Volume %) | | | | | |
|---|---|---|---|---|---|---|
| | ethylene | ethyl methyl | Chemical | Chemical | Chemical | Fluoroethylene |
| | carbonate | carbonate | Formula | Formula | Formula | carbonate |
| | (EC) | (EMC) | 1-A | R-1 | R-2 | (FEC) |
| Example 1 | 30 | 50 | 20 | — | — | — |
| Example 2 | 30 | 30 | 40 | — | — | — |
| Example 3 | 30 | 55 | 15 | — | — | — |
| Example 4 | 20 | 40 | 40 | — | — | — |
| Example 5 | 20 | 75 | 5 | — | — | — |
| Example 6 | 30 | 60 | 10 | — | — | — |
| Example 22 | 30 | 70 | — | — | — | — |
| Example 23 | 10 | 50 | 40 | — | — | — |
| Example 24 | 30 | 65 | 5 | — | — | — |
| Example 25 | 30 | 50 | — | 20 | — | — |
| Example 26 | 30 | 50 | — | — | 20 | — |
| Example 27 | — | 50 | 20 | — | — | 30 |

### Example 38

### Evaluation of High-Temperature Storage Characteristics

The lithium secondary batteries manufactured in the examples and comparative examples were subjected to an activation (formation) process by charging at a rate of 0.2C for 3 hours, followed by charging at a constant current/constant voltage condition of 0.33C to 4.2V at 25° C. (0.05C cut-off) until SOC 100% was reached, and then stored at high temperature (60° C.) for 16 weeks.

During the initial charge-discharge cycle, the capacity was confirmed at room temperature, then charged to SOC 50 based on discharge capacity, and discharged at a current of 2.5C for 10 seconds to measure the resistance based on the voltage drop difference, which was taken as the initial resistance. After 16 weeks of storage at 60° C., the resistance was measured again using the same method, and the resistance increase rate was calculated using the following formula. Some of the results are shown in Table 2.

$$Resistance Increase Rate ( \% ) = ( Final Resistance - Initial Resistance ) / ( Initial Resistance ) \times 100$$

Additionally, the relative values (%) of the initial resistance of the lithium secondary batteries in the examples and comparative examples compared to the initial resistance of the lithium secondary battery in Example 16 are shown in Table 2.

### Example 39

### Evaluation of High-Temperature Gas Generation

The lithium secondary batteries manufactured in the examples and comparative examples were subjected to an activation (formation) process by charging at a rate of 0.2C for 3 hours, followed by charging at a constant current/constant voltage condition of 0.33C to 4.2V at 25° C. (0.05C cut-off) until SOC 100% was reached, and then stored at high temperature (60° C.) for 16 weeks. Afterward, the gas generation amount was analyzed, and the relative values of the gas generation amount of the lithium secondary battery in Example 16 are shown in Table 2.

TABLE 2

| | Relative Value of | | Relative Value |
|---|---|---|---|
| | Initial Resistance | Resistance | of Gas Generation |
| | (% compared to | Increase | (% compared to |
| | Example 16) | Rate (%) | Example 16) |
| Example 1 | 105.5 | 11.52 | 47 |
| Example 2 | 121.3 | 1.81 | 30 |
| Example 3 | 102.3 | 14.55 | 49 |
| Example 4 | 124.6 | 6.97 | 41 |
| Example 5 | 101.8 | 16.24 | 65 |
| Example 6 | 103.4 | 15.23 | 53 |
| Example 22 | 100 | 31.79 | 100 |
| Example 23 | 127.1 | 33.48 | 87 |
| Example 24 | 99.6 | 27.94 | 91 |
| Example 25 | 118.2 | 404.8 | 152 |
| Example 26 | 110.6 | 16.04 | 79 |
| Example 27 | 127.6 | 38.64 | 108 |

Referring to Table 2, it can be seen that the lithium secondary batteries of the examples, which comprise a non-aqueous electrolyte including the compound of Chemical Formula 1 and ethylene carbonate in a specific volume ratio, exhibit reduced initial resistance and resistance increase rate at high temperatures, and significantly reduced gas generation.

1. A non-aqueous electrolyte comprising:
a lithium salt; and
an organic solvent comprising
a cyclic carbonate compound; and
a compound represented by Chemical Formula 1-1: 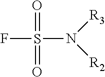
wherein R2 and R3 each are hydrogen, an alkyl group having 1 to 10 carbon atoms, or an aryl group having 6 to 20 carbon atoms; and
wherein the organic solvent comprises the compound represented by Chemical Formula 1-1 in an amount from about 10 vol % to about 30 wt %.

2. The non-aqueous electrolyte of claim 1, wherein at least one of R2 and R3 is methyl.

3. The non-aqueous electrolyte of claim 1, wherein the compound represented by Chemical Formula 1-1 is represented by Chemical Formula 1-A:

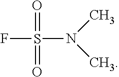

4. The non-aqueous electrolyte of claim 1 comprising the compound represented by Chemical Formula 1-1 in an amount of about 20 vol %.

5. The non-aqueous electrolyte of claim 1, wherein the cyclic carbonate comprises at least one selected from the group consisting of ethylene carbonate, propylene carbonate (PC), vinylene carbonate (VC), methyl ethylene carbonate (MEC), 1,2-butylene carbonate, 2,3-butylene carbonate, 1,2-pentylene carbonate, 2,3-pentylene carbonate, or methyl vinylene carbonate, ethyl vinylene carbonate, 1,2-dimethyl vinylene carbonate, 1,2-diethyl vinylene carbonate, 1-ethyl-2-vinylethylene carbonate, 1-n-propyl-2-vinylethylene carbonate, 1-methyl-2-vinyl ethylene carbonate, 1,1-divinyl ethylene carbonate, 1,2-divinyl ethylene carbonate, 1,1-dimethyl-2-ethylene carbonate, 1,1-diethyl-2-methylene-ethylene carbonate, fluoroethylene carbonate, 1,2-difluoroethylene carbonate, 1,1-difluoroethylene carbonate, 1,1,2-trifluoroethylene carbonate, tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, and trifluoromethylethylene, fluoro vinylene carbonate, and trifluoromethyl carbonate.

6. The non-aqueous electrolyte of claim 1, wherein the cyclic carbonate comprises ethylene carbonate.

7. The non-aqueous electrolyte of claim 1, wherein the organic solvent further comprises at least one linear carbonate compounds selected from the group consisting of dimethyl carbonate (DMC), diethyl carbonate (DEC), dipropyl carbonate (DPC), ethyl methyl carbonate (EMC), methylpropyl carbonate (MPC), and ethyl propyl carbonate (EPC).

8. The non-aqueous electrolyte of claim 1 further comprising an additional compound selected from the group consisting of a linear ester-based organic compound, a cyclic ester-based organic compound, an ether-based organic compound, a glyme-based compound, and a nitrile-based organic compound, and mixtures thereof.

9. The non-aqueous electrolyte of claim 1 further comprising an additive selected from the group consisting of lithium difluorophosphate (LiDFP), vinylene carbonate, vinylethylene carbonate, fluoroethylene carbonate, Propane sultone, Propene Sultone, Succino Nitrile (succinonitrile), Adiponitrile, Ethylene sulfate, LiBOB (Lithium bis-(oxalato)borate), LiBF4 (Lithium tetrafluoroborate), LiDFOB (Lithium difluoro (oxalato) borate), LiDFOP (Lithium difluoro bis(oxalato), 3-trimethoxysilanyl-propyl-N-aniline (TMSPa), Tris(trimethylsilyl) Phosphite (TMSPi), a compound represented by Chemical Formula 2, and mixtures thereof.

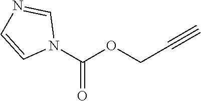

10. The non-aqueous electrolyte of claim 1, wherein the lithium salt comprising Li+ and an anion selected from the group consisting of F−, Cl−, Br−, I−, NO3−, N(CN)2−, BF4−, ClO4−, AlO4−, AlCl4−, PF6−, SbF6−, AsF6−, B10Cl10−, BF2C2O4−, BC4O8−, PF4C2O4−, PF2C4O8−, (CF3)2PF4−, (CF3)3PF3−, (CF3)4PF2−, (CF3)5PF−, (CF3)6P−, CF3SO3−, C4F9SO3−, CF3CF2SO3−, (FSO2)2N−, CF3CF2(CF3)2CO−, (CF3SO2)2CH—, CH₃SO3−, CF3(CF2)7SO3−, CF3CO2—, CH₃CO2−, SCN− and (CF3CF2SO2)2N−, and mixtures of.

11. The non-aqueous electrolyte of claim 1, wherein the non-aqueous electrolyte comprises the lithium salt at a molar concentration of 0.5 M to 5.0 M.

12. A lithium secondary battery comprising:
an anode;
a cathode facing the anode;
a separator interposed between the anode and the cathode; and
the non-aqueous electrolyte of claim 1.

13. The lithium secondary battery of claim 12, wherein the anode includes an anode active material, and the anode active material includes at least one selected from carbon-based active materials and silicon-based active materials.
